(19) United States
(12) Patent Application Publication
(10) Pub. No.: US 2016/0357919 A1
(43) Pub. Date: Dec. 8, 2016

(54) CENTRALIZED FORMULARY SYSTEM AND METHOD

(71) Applicants: Morgan Bojorquez, Charlestown, KY (US); Stephen Marco, Louisville, KY (US)

(72) Inventors: Morgan Bojorquez, Charlestown, KY (US); Stephen Marco, Louisville, KY (US)

(73) Assignee: HUMANA INC., Louisville, KY (US)

(21) Appl. No.: 13/460,216

(22) Filed: Apr. 30, 2012

Related U.S. Application Data
(60) Provisional application No. 61/480,626, filed on Apr. 29, 2011.

(51) Int. Cl. G06F 19/00

(52) U.S. Cl. CPC G06F 19/326

(57) ABSTRACT

A centralized formulary system for maintaining formulary data to service the needs of multiple user groups. Formulary and drug information is updated automatically when received from outside sources. In addition to drug identifying data, line of business and utilization management protocol data is associated with the formulary data. The formulary data further comprises coverage data for health plans that use the formularies. The additional business data maintained in association with the formularies facilitates the retrieval and editing of formulary data for various business needs, including compliance with third party requirements. The system allows users to analyze formulary data, edit formulary data, produce reports regarding formulary data, and export files. The system also supports submission of formulary data to third party computer systems.

### CROSS-REFERENCE TO RELATED APPLICATIONS

This application claims priority to U.S. Provisional Application Ser. No. 61/480,626, filed Apr. 29, 2011, titled CENTRALIZED FORMULARY SYSTEM AND METHOD, the content of which is incorporated by reference as if fully recited herein.

### BACKGROUND OF THE INVENTION

Drug formularies are commonly maintained by health benefits companies to track covered drugs for various health plans offered to different member groups. Formularies not only include the names of drugs, but details on each drug such as dosage instructions, quantity limits, drug tier information, therapeutic category, and SKU numbers. Each drug formulary may have tens of thousands of SKUs each identifying a different combination of drug details.

Depending on the types of services a health benefits company offers, including different types of health plans, the company may need to maintain numerous formularies. For health benefit plans that are associated with government programs such as Medicare or Medicaid, the content of formularies may be regulated by the government. Other influences on the content of formularies include Food and Drug Administration (FDA) approval or disapproval of the safety of certain drugs, the availability of generic drugs versus brand name drugs, and the removal of drugs from the market by the manufacturer. All of these factors require companies to continually review and update the content of their formularies. A health benefits company that maintains numerous formularies may incur substantial costs in keeping the formularies updated and consistent for numerous user groups that require access to the formulary data for different purposes. User groups often need access to formulary in order to perform searches, access details about particular drugs, run reports, export information, or make their own changes to the formularies.

User groups across a health benefits company may access and maintain formulary data in different ways. Some groups may rely on simple databases while others use spreadsheets. Various computer tools and systems are employed so that the groups can maintain not only drug details but also utilization management, insurance plan, and other coverage details such as co-pay requirements, prior authorization requirements, quantity limits, step requirements, etc. One common source for formulary coverage details is a claims processor that uses coverage information in processing member prescription claims. Claims processor data may be updated frequently to reflect changes in drug dosages and pricing as well as plan coverage. The claims processor data, which is used to process transactions, is not readily accessible to employees and agents of the health benefits company that manage and develop health plans and benefits. Data changes reflected in the claims processor may be communicated upon request to one or more user groups but there is no consistent or systematic approach for accessing and obtaining current data.

Regardless of the types of computer tools or systems that are used, it is problematic when different user groups obtain and maintain formulary and coverage data in different ways (e.g., databases, spreadsheets, e-mail messages) from different sources (e.g., claims processor, other groups) as it increases the likelihood that a particular user group is accessing outdated formulary and coverage data. Furthermore, any changes made by one user group may not be communicated to other user groups unless the user groups collectively make a concerted effort to communicate changes. The pressure to keep formularies current is further exacerbated by the need for health benefit companies to send accurate formulary information to third party vendors and other entities that facilitate providing services to members. It is also important for a health benefits company to be able to share current and consistent formulary data with members so that members remain informed about the drugs covered by a particular health plan and the level of coverage provided.

### SUMMARY OF THE INVENTION

The present invention is a computerized system for managing formulary data, including automatically updating formulary data as new formulary data is received from outside sources, and allowing multiple users to access formulary data for different purposes. In one embodiment, a server receives formulary data about a plurality of formularies from a first source, receives drug information from a second source, stores the information in a database, provides multiple users with access to the stored information, receives instructions from the users and changes stored information based on those instructions, exports files containing formulary information, and supports an online formulary search for multiple remote users. The formulary data may be combined with utilization management protocol and coverage data so that the database comprises information about prior authorization groups, step therapy groups, related context drug lists, drug dosage information, drug codes, and drug cost information. In some embodiments, the centralized system allows users to create new formularies and formulary identification information. In some embodiments, the system audits all changes to formulary information made by users. The system may also allow users to produce reports regarding formulary information. The system may also track approvals made by different user groups regarding information that is to be submitted to remote locations. The system may further support an online drug search in which computer users can review formulary information associated with different health benefit plans.

### BRIEF DESCRIPTION OF THE DRAWINGS

FIG. 1 is a sample home page of a web interface of an example embodiment with a drug search tab;

FIG. 2 is the sample home page and drug search tab of FIG. 1 after a search has been completed;

FIG. 3 is a sample copy formulary tab of a web interface of an example embodiment;

FIG. 4 is a sample import formulary tab of a web interface of an example embodiment;

FIG. 5 is a sample edit formulary tab of a web interface of an example embodiment;

FIG. 6 is a sample related context lists tab of a web interface of an example embodiment;

FIG. 7 is a sample context drug list search tab of a web interface of an example embodiment;

FIG. 8 is the sample context drug list search tab of FIG. 7 after a search has been completed;

FIG. 9 is a sample drug-search tab of a web interface of an example embodiment shown along with the context drug list search tab of FIG. 8;

FIG. 10 is the sample drug-search tab of FIG. 9 after a search has been run and results are listed;

FIG. 11 is a sample new context drug list tab of a web interface of an example embodiment;

FIG. 12 is a sample copy context drug list tab of a web interface of an example embodiment;

FIG. 13 is a sample edit context drug list tab of a web interface of an example embodiment;

FIG. 14 is a sample related formularies tab of a web interface of an example embodiment;

FIG. 15 is a sample prescription drug guide report page of a web interface of an example embodiment;

FIG. 16 is a sample import FRF tab of a web interface of an example embodiment;

FIG. 17 is a sample PA group description search tab of a web interface of an example embodiment;

FIG. 18 is a sample new PA group tab of a web interface of an example embodiment;

FIG. 19 is a sample edit PA group tab of a web interface of an example embodiment;

FIG. 20 is a sample related formularies tab of a web interface of an example embodiment;

FIG. 21 is a sample step therapy group description tab of a web interface of an example embodiment;

FIG. 22 is a sample edit ST group tab of a web interface of an example embodiment;

FIG. 23 is a sample related formularies tab of a web interface of an example embodiment;

FIG. 24 is a sample generate files tab of a web interface of an example embodiment;

FIG. 25 is a sample approval tab of a web interface of an example embodiment;

FIG. 26 is a sample clinical sign-off tab of a web interface of an example embodiment;

FIG. 27 is a sample formulary ops approval tab of a web interface of an example embodiment;

FIG. 28 is a sample confirm tab of a web interface of an example embodiment;

FIG. 29 is a sample confirm results tab of a web interface of an example embodiment;

FIG. 30 is a sample online provider drug list search page of a web interface of an example embodiment;

FIG. 31 is a sample provider drug search results page of a web interface of an example embodiment;

FIG. 32 is a system and logic diagram of an exemplary embodiment; and

FIG. 33 is a block diagram of a centralized formulary process according to an example embodiment.

### DETAILED DESCRIPTION

One embodiment comprises a centralized formulary system that is automatically updated as formulary, drug, and coverage information is received from different sources. It may be accessed by different user groups through an on-line portal, and allows user groups to edit formulary information, create reports, and export information to remote systems.

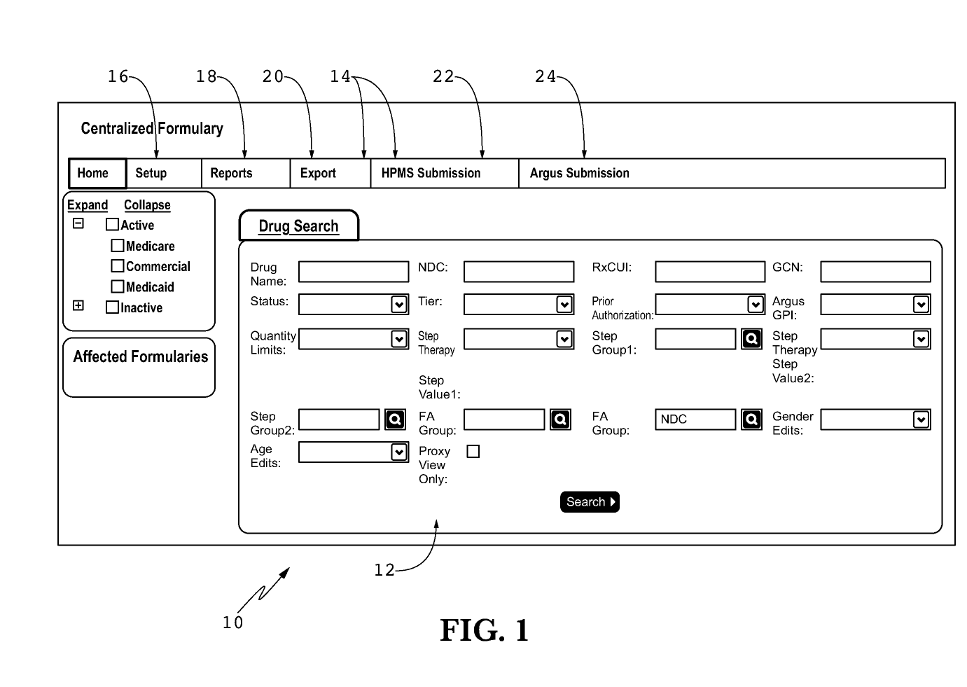

Referring to FIG. 1, a sample home page 10 of a web portal with an open drug search tab 12 of an example embodiment is shown. The home page 10 may be accessed by a user after logging into the web portal by providing a user name and password. On the home page 10, the user can search the centralized formulary database and access different pull-down menus 14, including Setup 16, Reports 18, Export 20, health plan management system (HPMS) submission 22, and claims processor submission 24. The drug search tab 12 allows the user to perform formulary searches, and results may be filtered by selecting whether the plan with which the formulary is associated is active or inactive, and if active, whether it is a Medicare, Commercial, or Medicaid plan. An example of searchable fields that may appear in a drug search tab is shown in Appendix 1.0. Search results may be obtained at the Group Category Number (GCN) level, National Drug Category (NDC) level, or Step Therapeutic Category (STC) level. Examples of fields for search results at the GCN, NDC, and STC levels may be viewed in Appendices 1.1, 1.2, and 1.3, respectively.

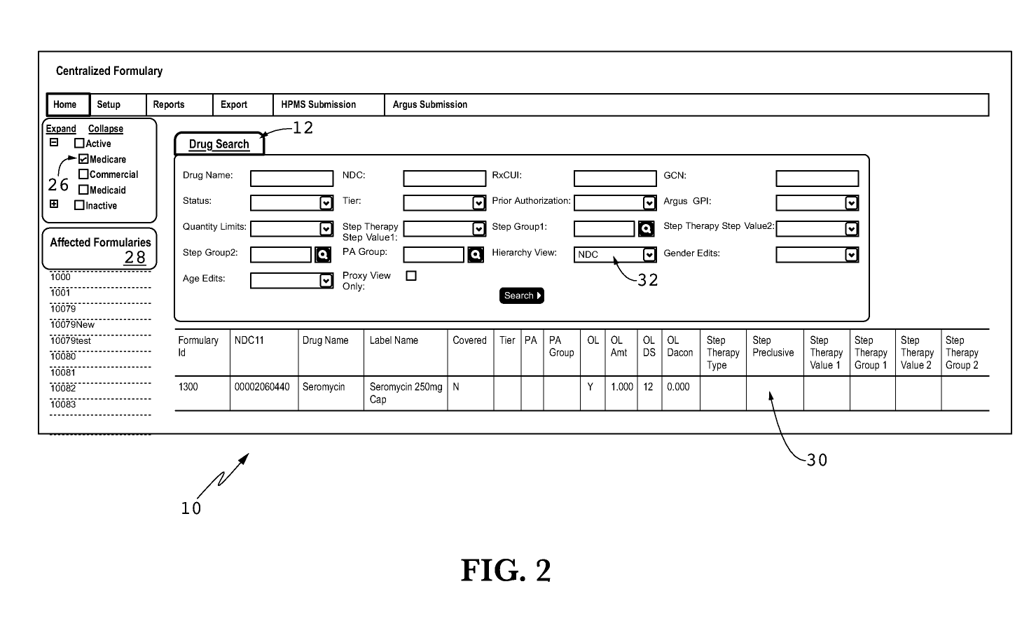

Referring to FIG. 2, the sample home page of FIG. 1 is shown after a search request has been entered by the user. A user may filter the formulary results by selecting the check boxes 26 that correspond to active Medicare plans. In the example, Formulary 1000 has been selected from the list of Affected Formularies 28, and an additional search criterion has been entered in the Drug Search tab 12, particularly limiting the status of drugs to “Pending.” Results of this search are listed in a search results table 30 located below the Drug Search tab 12. Formulary attributes may be viewed at different levels, including the National Drug Category (NDC) level, or hierarchy levels such as Group Category Number (GCN) and Step Therapeutic Category (STC) levels. Different levels may be viewed by selecting the desired level from the Hierarchy View pull-down tab 32.

The centralized formulary system allows a user to create a new formulary by accessing the Setup menu 16 and selecting an option to create a new formulary. In creating a new formulary, the system may require the user to enter formulary elements, including: formulary identifier; formulary name; formulary status; formulary format; number of tiers; line of business (e.g., Medicare, Commercial, Medicaid); type (open or closed); and description of the formulary. An example of new formulary criteria and field information is shown in the chart in Appendix 1.4. Upon entering the necessary information, the system may generate a new formulary with NDCs, unless the formulary status entered is “inactive.” The system may also store all information regarding creation and subsequent changes made to the formulary for audit purposes.

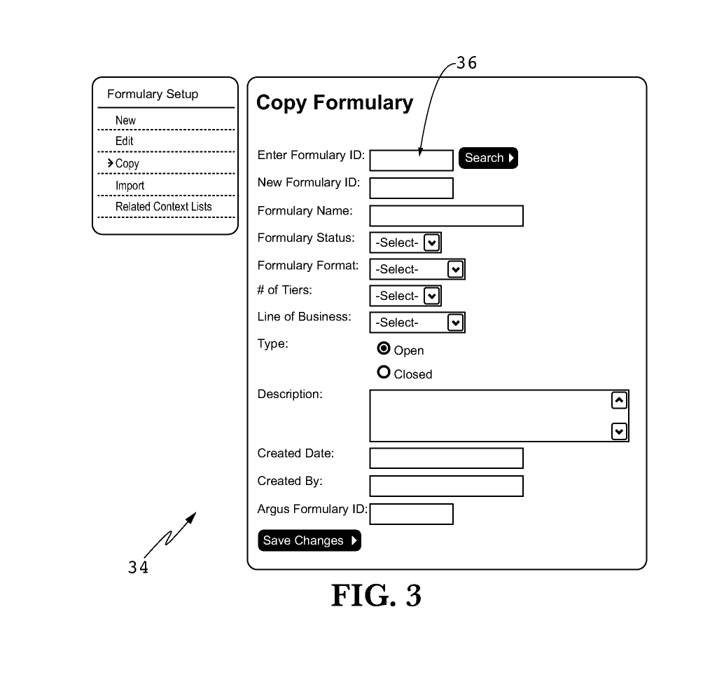

The system may also allow a user to create a new formulary by copying an existing formulary. Referring to FIG. 3, a sample copy formulary tab 34 of an example embodiment is shown. This tab may be accessed through the Setup drop down menu 16 shown in FIGS. 1 and 2. A user can begin the copying process by entering a formulary identifier for an existing formulary into the formulary identifier search box 36. The system searches for a corresponding identifier, and if found, presents information related to that formulary for validation by the user. When the user has found the formulary to be copied, a new formulary identifier may be entered and the new formulary is created.

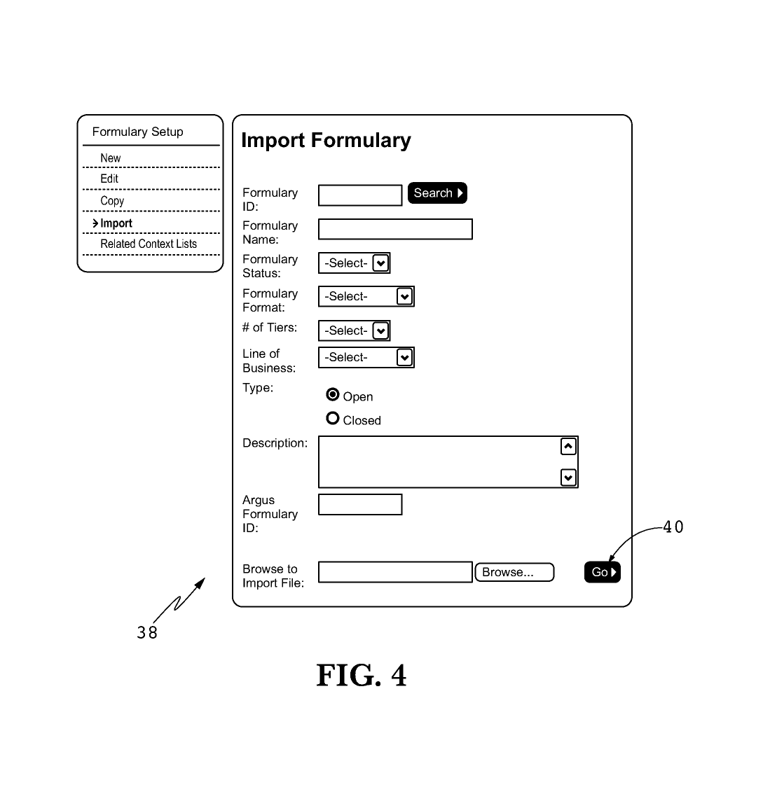

A new formulary may also be created by importing a formulary. Referring to FIG. 4, an import formulary tab 38 of an example embodiment is shown. This tab allows the user to enter criteria about the formulary as well as import the formulary file. An example of criteria and field guidelines is shown in Appendix 1.5. Once the user has specified the criteria and selected a file to import, selection of the Go button 40 imports the file into the system. An example of the fields and field criteria of a file that may be imported is included in Appendix 1.6.

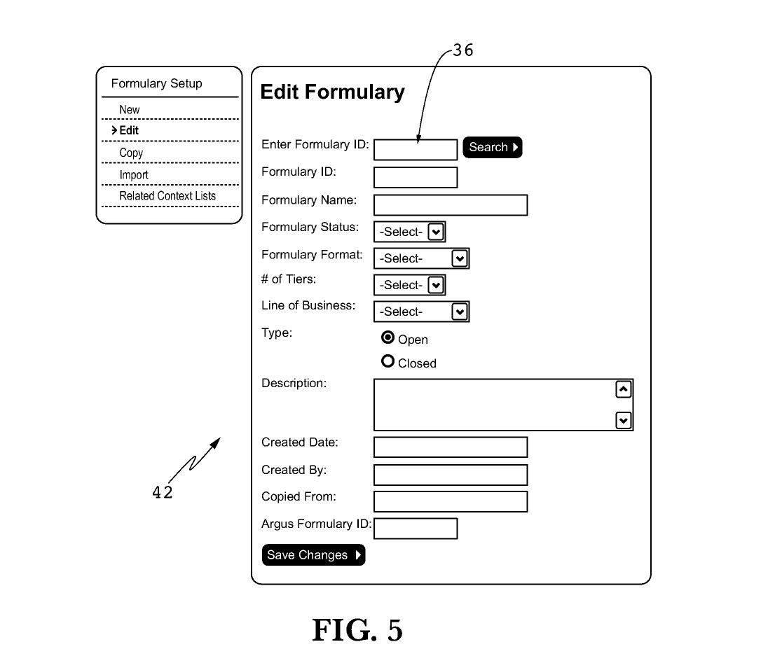

Formularies already existing in the centralized formulary system may be edited by a user. Referring to FIG. 5, an Edit Formulary tab 42 of an example embodiment is shown. This tab 42 may be accessed through the Setup drop down menu 16 shown in FIGS. 1 and 2. The user may enter the identifier of the formulary in the Enter Formulary identifier box 36. Once the formulary has been located and the fields are populated on the edit formulary tab 42, the user may update the information and save the changes. Examples of changes that may be made to a formulary include changing the number of tiers or updating the status from inactive to active. Many other changes may also be made through the edit formulary tab 42.

In some embodiments, the system creates new formularies and assigns a parent/child relationship to an existing formulary. In these embodiments, the system may store and display data to users that identifies the parent formulary of a child formulary, or vice versa. This feature is provided through the use of a parent identifier or child identifier field attached to each formulary. The system may also identify the differences between a parent formulary and child formulary on a per value basis and print reports identifying differences. Furthermore, in some embodiments edits made to a parent formulary's record may automatically be made to a child formulary's record as well. In different embodiments, the system may perform different functions based on the similarities or dissimilarities between parent/child formularies.

The system allows a user to view context drug lists associated with a formulary, and change the relationship of context drug lists with the formulary. Context drug lists may override or add information to a formulary. For example, a context drug list may add a given attribute to some drugs on a formulary, such as mark all formulary drugs indicated for diabetes. A context drug list may override a formulary's included/excluded status on a drug (whether the drug is covered or not covered by a plan's formulary) or may override a formulary's brand/generic status on a drug (whether considered a brand or generic by a plan's formulary).

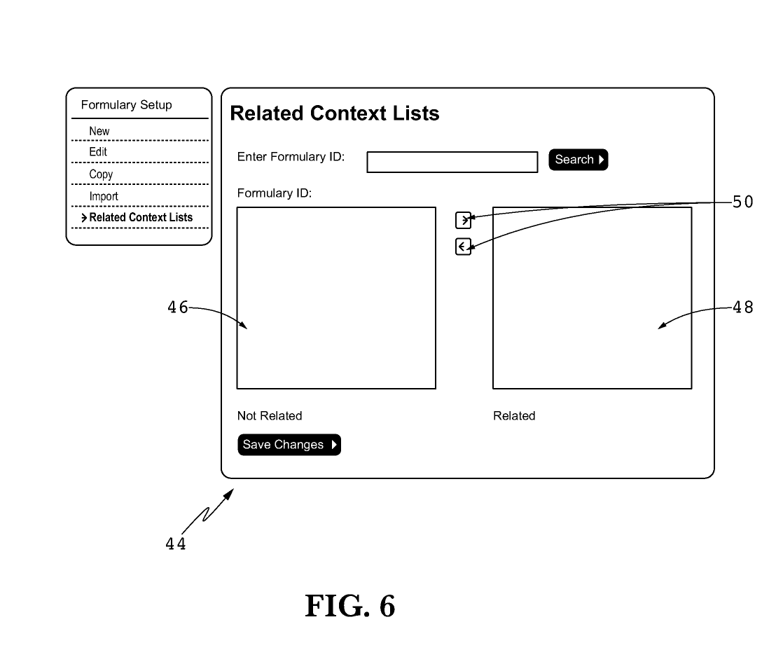

The centralized formulary system may allow a user to view context drug lists related to formularies, and update the status of the relationship between context drug lists and formularies. Referring to FIG. 6, a related context lists tab 44 of an example embodiment is shown. Using this tab, the user can enter a formulary identifier and search to see which formularies have related context drug lists and which do not. Those that do not have related context drug lists may appear in the Not Related box 46, while those that do have related context drug lists may appear in the Related box 48. The user can also select a formulary and move it from one status to the other using the arrow buttons 50. For example, the user can move a formulary from the Not Related Box 46 to the Related Box 48 and vice versa.

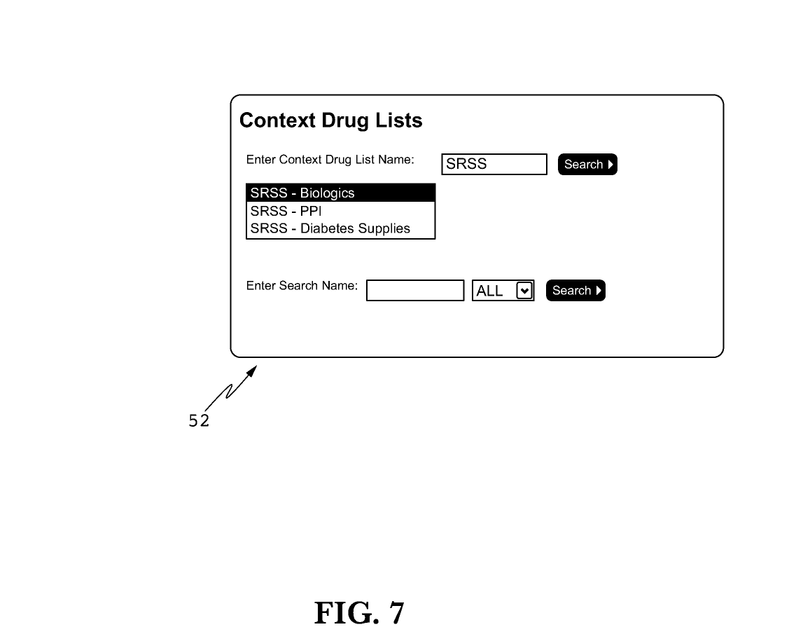

Context drug lists may also be searched by a user. Referring to FIG. 7, a Context Drug List search tab 52 of an example embodiment is shown. A user may enter the name of a context drug list into the tab to see if any drug lists match the criteria. The user may select one of the drug lists, and then enter a search name and select a category to search for specific drugs. The categories may include: All (return all NDCs in the context drug list); DCC (Drug Class Category); STC, GCN (categories that expand to NDC); or NDC (NDC's display without a category).

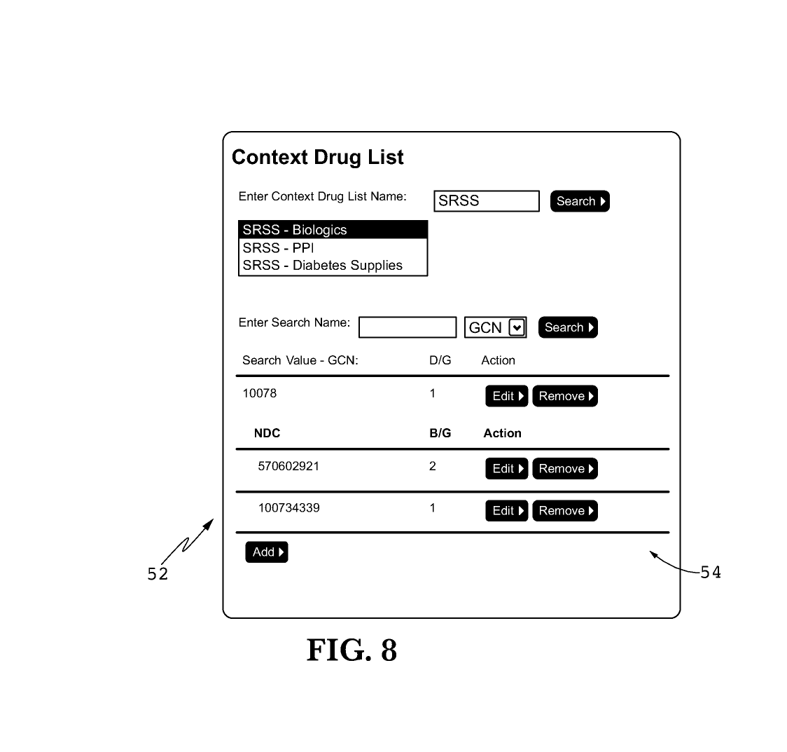

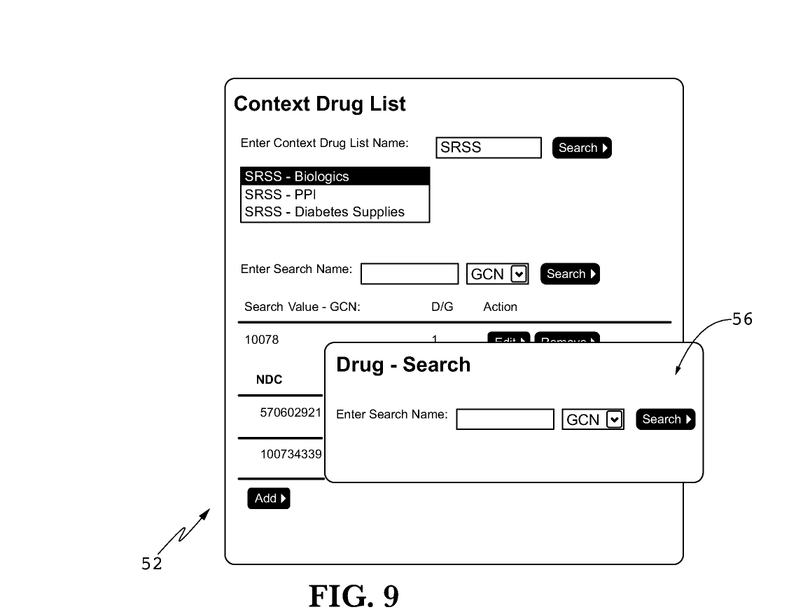

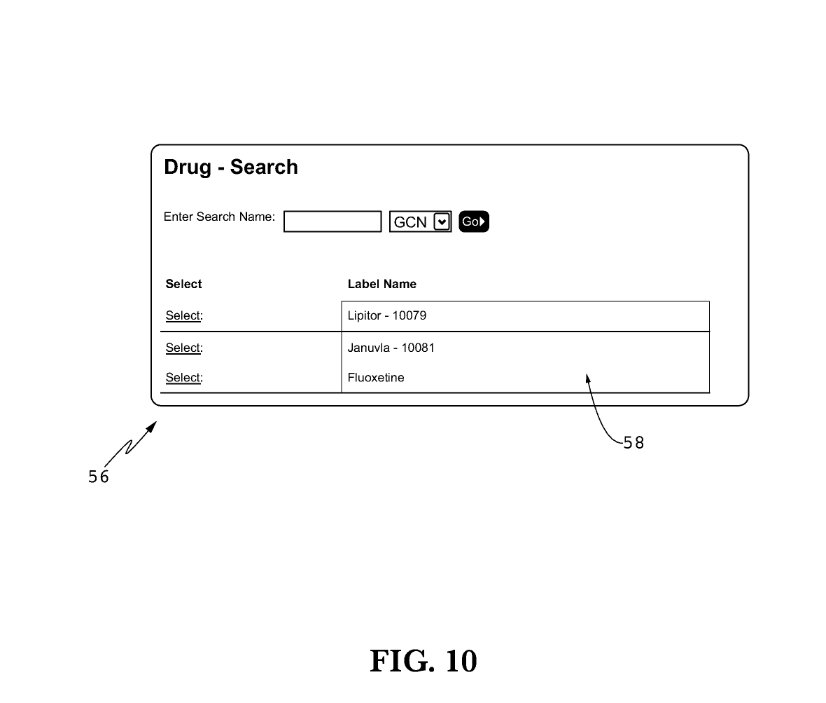

Referring to FIG. 8, the Context Drug List search tab 52 appears after a search is completed. A record list 54 shows the results of the search. Using the buttons on the record list, listed drugs may be edited or removed and drugs not listed may be added. Referring to FIG. 9, a Drug-Search tab 56 is shown along with the context drug list tab 52. The Drug-Search tab may appear if a user has selected an option to add a drug. The user may search for a drug by entering a name and by selecting a category. The system may display available drugs responsive to the search in a results list 58 as shown in FIG. 10. The user may then select one of the drugs to add to the context drug list.

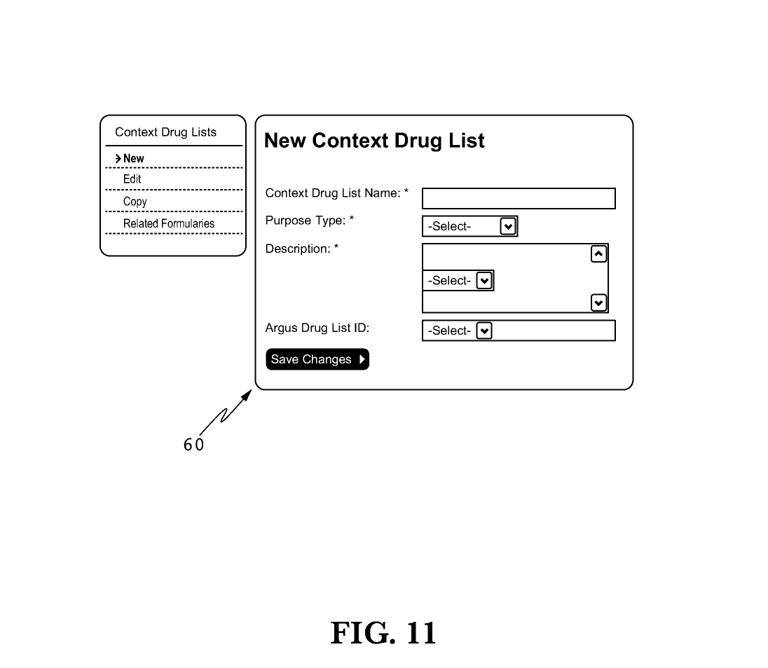

If desired, a user may create a new context drug list. Referring to FIG. 11, a New Context Drug List tab 60 of an example embodiment is shown. This tab allows a user to enter information about the new context drug list, including a name, a purpose type, and a description. An example of fields and field criteria for an embodiment of a New Context Drug List tab 60 is set forth in Appendix 1.7. Once the user has entered the information and saved the changes, the list may be retrieved and edited.

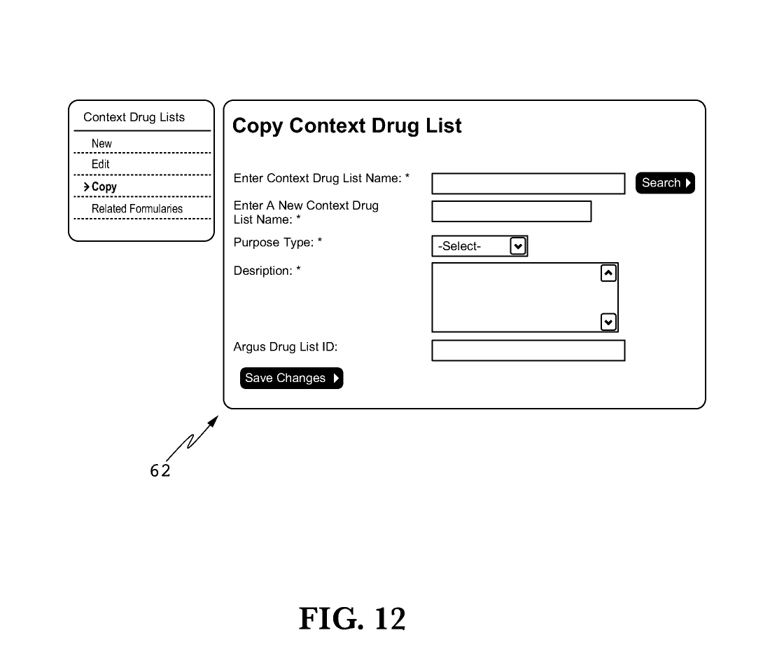

A new context drug list may also be created by copying an existing context drug list. Referring to FIG. 12, a Copy Context Drug List tab 62 of an example embodiment is shown. The user may enter the name of an existing list and provide a name for the new list to be created. Additional fields on this tab 62 may allow the user to validate the requested drug list. Once a user makes a copy and saves a new list with its new name, the user may then edit the new context drug list.

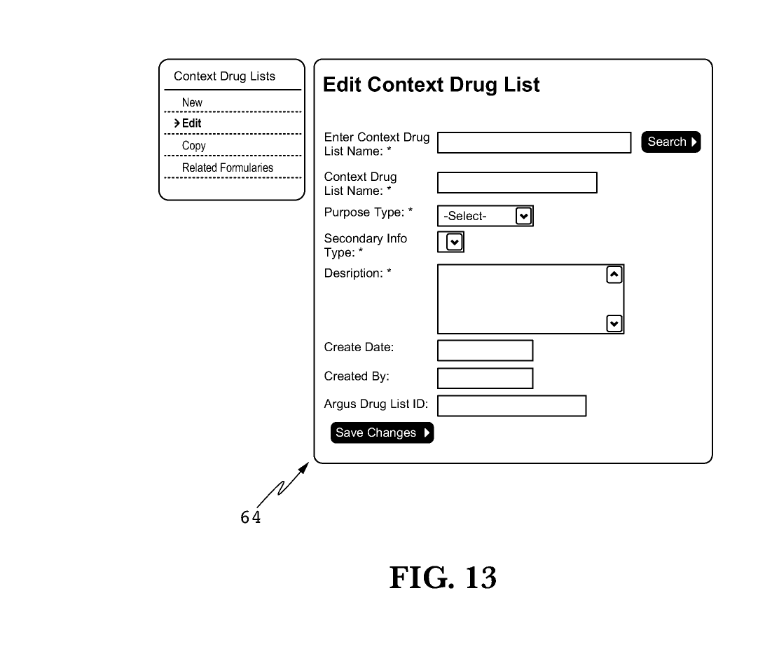

Referring to FIG. 13, an Edit Context Drug List tab 64 of an example embodiment is shown. Using this tab, the user can search for the context drug list to edit, and then edit the different fields, including the purpose/type, and description.

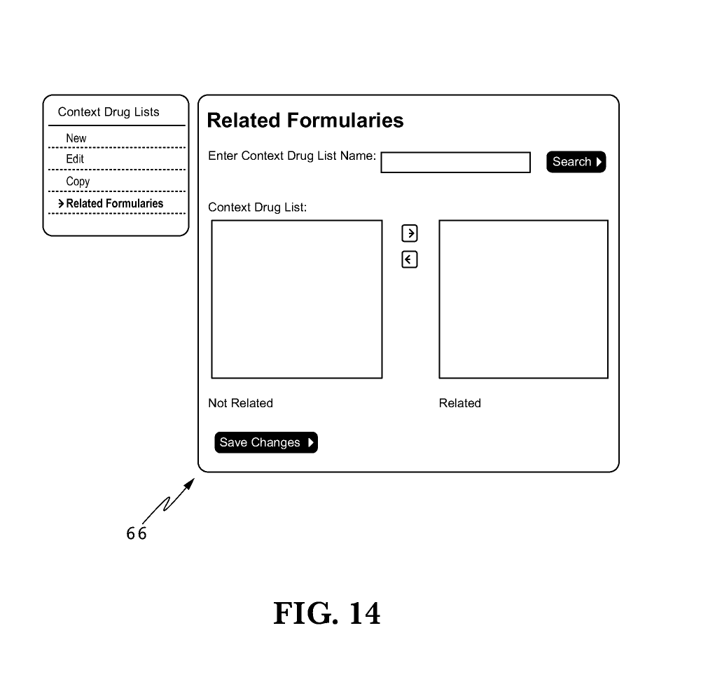

The system may also allow a user to view the formularies to which a particular drug list is related and update the status of the relationships. Referring to FIG. 14, a Related Formularies tab 66 of an example embodiment is shown. Using this tab, the user can search for a context drug list and view the formularies that are currently unrelated and related to that context drug list. The user may use the arrow buttons 50 to move formularies between the ‘not related’ box 46 and the ‘related’ box 48. The changes may then be saved in the system.

The system may perform automatic comparisons of the Non-Matched NDC List that is provided by the Center for Medicare and Medicaid Services (CMS) to the Food and Drug Administration (FDA) registry list and identify those NDCs that have become FDA listed in a predetermined time period and are also CMS approved. For example, the system may compare NDCs that have been FDA listed in the past 30 days and are also CMS approved. The system may also identify incremental changes, over a particular time period, for a particular NDC. This function may allow users to find products that have recently become FDA listed as well as review a NDC's history of changes.

The system may automatically set the status of any NDC that has been FDA listed and CMS approved. For example, it may set the status of such NDC's to ‘pay.’ However, the system may also allow a user to override the automatic status of a NDC to a different status as desired. In doing so, the system may require the user to record a reason for the override, such as member impact, competitive intelligence, CMS update, or FDA update. The system may also require a user to type an effective date and end date for the change, and to select a value for the NDC at issue, such as Test NDC or Term NDC. Other information may also be required in order for a user to enter an override.

Each month the system may automatically update FDA data, find changes in the data, and archive the prior month's status. In some embodiments, these functions may not be performed monthly, but on a different time schedule as desired. The system may also store additional information such as FDA alternatives, non-matched NDCs and alternatives within a particular GCN, and non-matched NDCs from CMS. FDA alternatives may be based on generic product indicator or electronic product code (GPI/EPC) logic, and taken from another source such as an electronic pharmacy list.

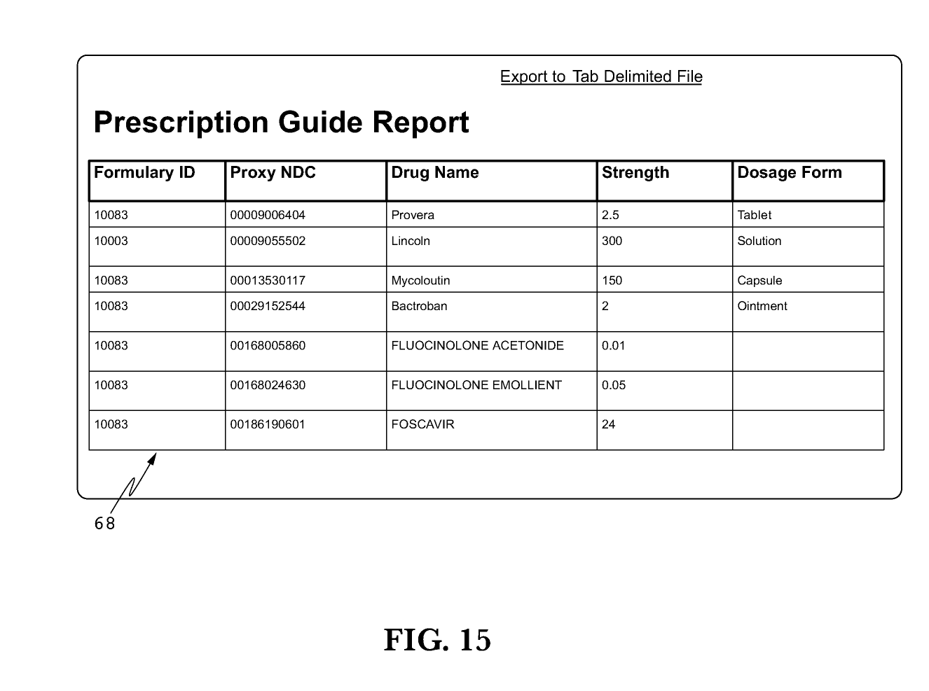

The system may allow a user to export formulary data and create reports. One way in which the system may export data is in the form of a Prescription Drug Guide. This function may be accessed through the Export menu 20 on the Home Page 10. The system may allow the user to select the contract year to be viewed, and the language, as well as other characteristics about the report. Once the user has selected the necessary criteria, the system displays the requested Prescription Drug Guide. Referring to FIG. 15, an example Prescription Drug Guide Report 68 according to an example embodiment is shown. As shown in FIG. 15, the Prescription Drug Guide Report may list Formulary identifiers, NDC information, Drug Names, Strengths, and Dosage Forms, as well as other information. The files generated by the system for the Prescription Drug Guide searched may be exported as a tab delimited file and saved for later use. An example of fields and field characteristics in an exported report is shown in Appendix 1.8. The system may also allow a user to export a printable drug list report.

The system may also allow a user to create and export many different types of reports. Reports may be exported in tab delimited form to applications such as Microsoft Excel® or may be exported in other formats that are easily printable or viewable in different programs. Ad hoc reports may be generated regarding Formulary identifiers, NCDs, Label Names, Coverages, drug alternatives, or any combination. Analytic Reports may be generated for formularies. Audit reports may be generated to show creation, sign-off/confirmation, approval, change, deletion, relationship change, imports, and exports, or any combination thereof for a formulary, context drug list, or other type of file maintained by the system. Audit reports may include user identifier, date, time, action, relevant identifiers, and formulary maintenance-record status information. First Data Bank (FDB) reports may be generated on a variety of topics. Examples of FDB reports are provided in Appendix 1.9.

The system may generate reports comparing formularies to one another. Formulary coverage reports may also be generated that display the percentage of drugs that are covered on that particular formulary, and the number and percentage of drugs that are on each tier. Formulary Reference File (FRF) change reports may be generated that show comparisons between two FRF files to identify additions, deletions, and any related NDC changes. Reports may also be generated showing non-matched NDCs that have become FDA listed. These reports may show changes made by users, including status changes and reasons for changes. Online drug lists may be compared in reports. Also, Prior Authorization (PA) and Step Therapy (ST) criteria for a drug may be generated by selecting a particular Formulary identifier. A ST criteria report may display each drug's name and its step therapy criteria. A PA criteria report may display drug names, covered uses, exclusion criteria, required medical information, age restrictions, prescriber restrictions, coverage duration, and any other criteria maintained in the system. Prescription plan reports may be generated to identify the formularies in a particular benefit plan. While the above provides examples of reports that may be generated by the system, it should be understood that in different embodiments the system may generate reports regarding any of the information it maintains, and the reports may be tailored for many different purposes.

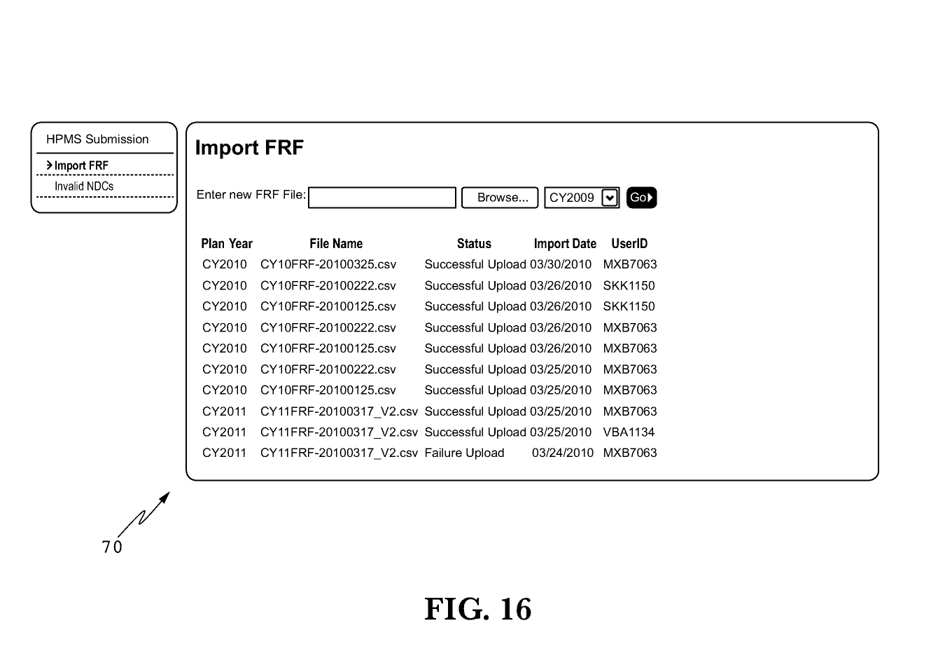

The system may allow a user to import a Formulary Reference File (FRF) that provides formulary updates. A FRF may be provided by the Centers for Medicare and Medicaid Services (CMS) on a monthly basis. A FRF may also be provided from a different source or at a different frequency. A FRF file may be imported by accessing the HPMS Submission menu 22 on the home page 10. Referring to FIG. 16, an Import FRF tab 70 according to an example embodiment is shown. In this embodiment the Import FRF tab 70 not only allows the user to search for a FRF file based on a contract year, but the tab also displays the last 10 imported FRF files.

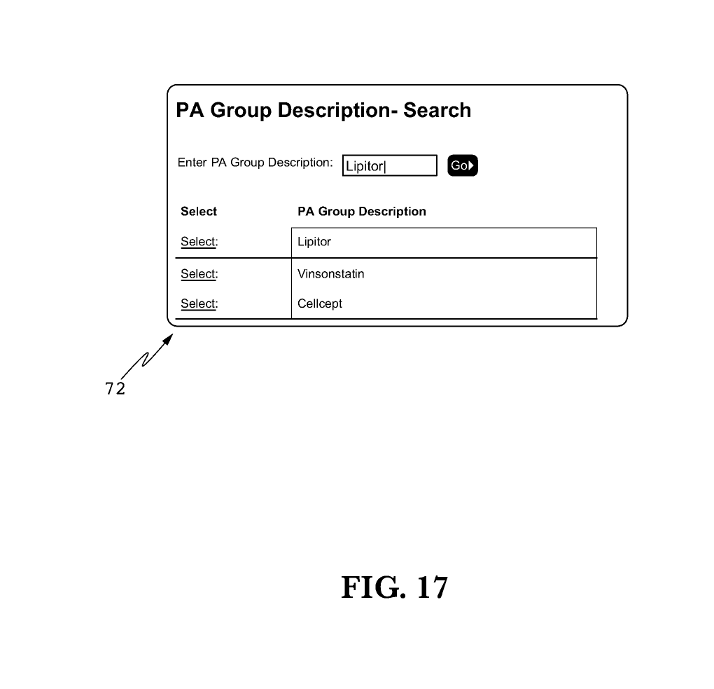

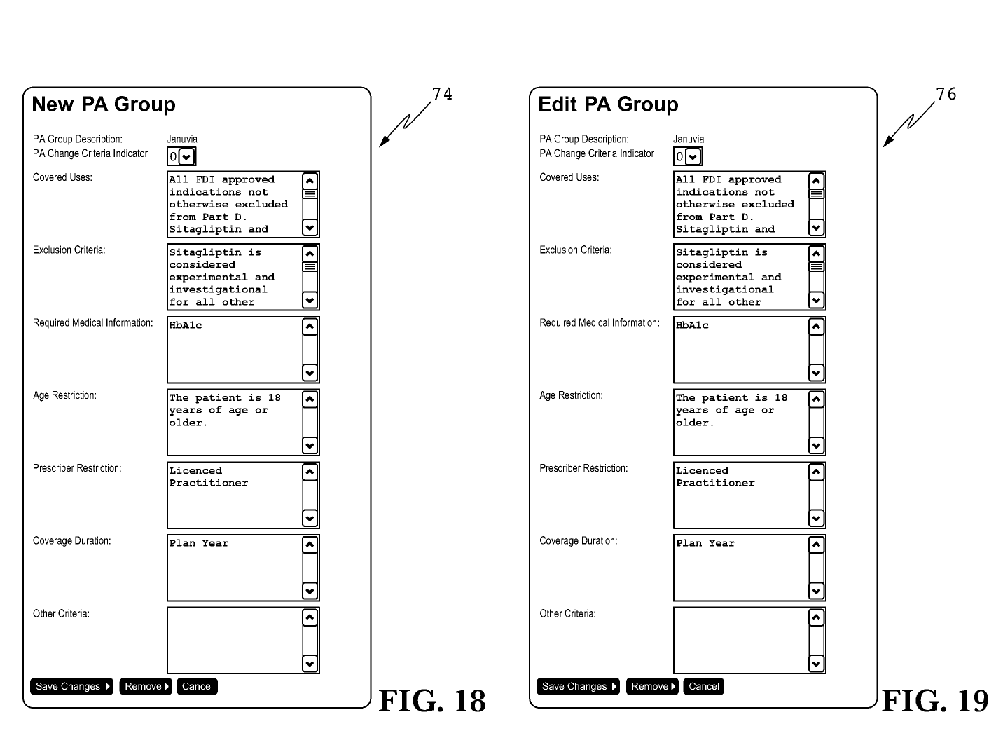

The system may also allow a user to access, create, view, and edit Prior Authorization (PA) criteria as part of the HPMS submission process. Referring to FIG. 17, a PA Group Description Search tab 72 of an example embodiment is shown. This tab 72 may be accessed from the HPMS Submission menu 22. Using this tab 72, the user may enter a value into the search box, for example Lipitor, and receive a list of matching PA Group names. The PA Group Search tab 72 also allows a user to select a listed PA Group and edit its properties. New PA Groups can also be created. Referring to FIG. 18, a New PA Group tab 74 of an example embodiment is shown. This tab allows the user to fill in the fields required to create a new PA group. As shown in FIG. 18, the fields may include the PA group description, exclusion criteria, required medical information, age restrictions, prescriber restrictions, and coverage duration. When the user selects a save option, the new PA group is created.

Existing PA Groups are edited in a similar manner. Referring to FIG. 19, an Edit PA Group tab 76 of an example embodiment is shown. This tab allows a user to make edits to an existing PA group and save the changes.

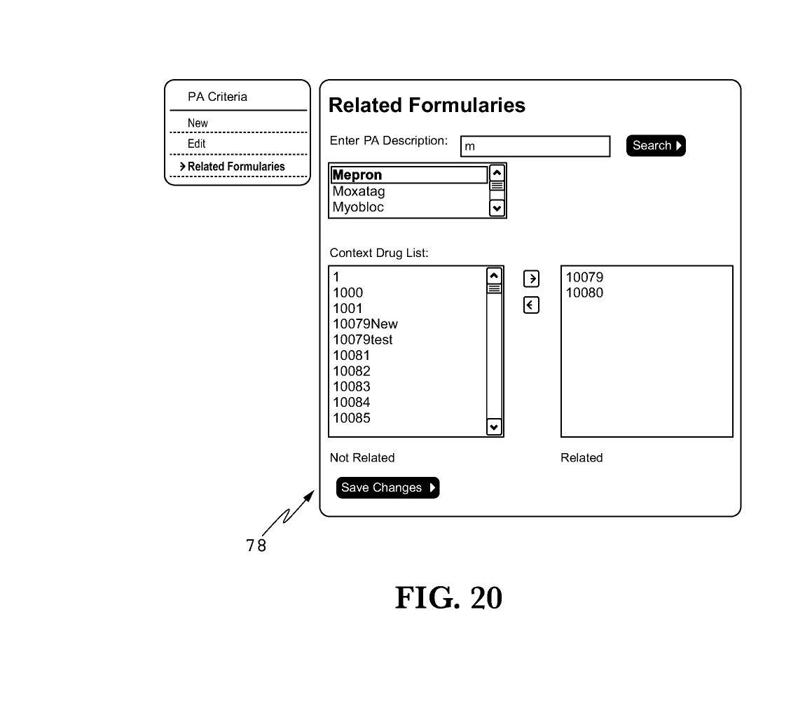

The system may provide the user with information about which formularies are related to a particular PA Group, and update the relationship between formularies and the PA Group. Referring to FIG. 20, a Related Formularies tab 78 according to an example embodiment is shown. A user can enter the name of a PA Group into the search box, and the system identifies which formularies are related and which formularies are not related. If a user wishes to change the relationship of a particular formulary, the user can select that formulary and use the arrow buttons to move the formulary from one status to another. Changes to relationships can then be permanently saved in the system.

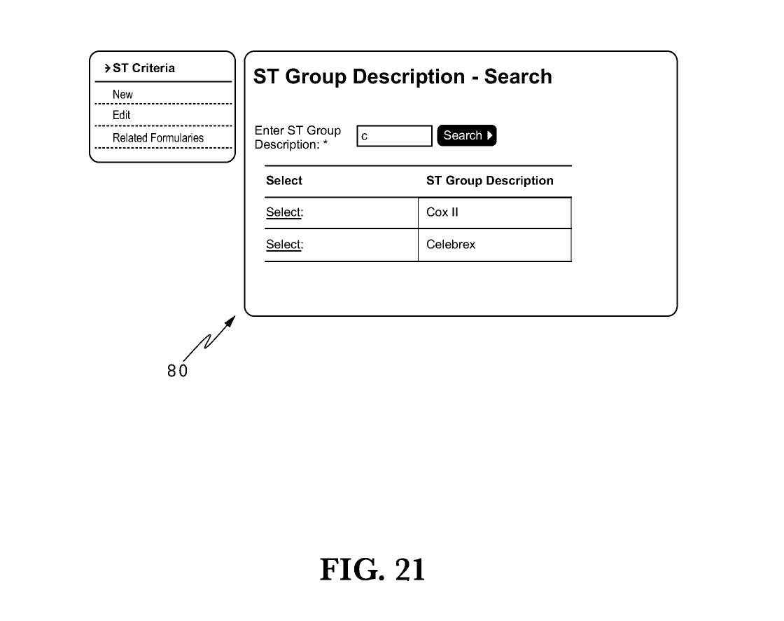

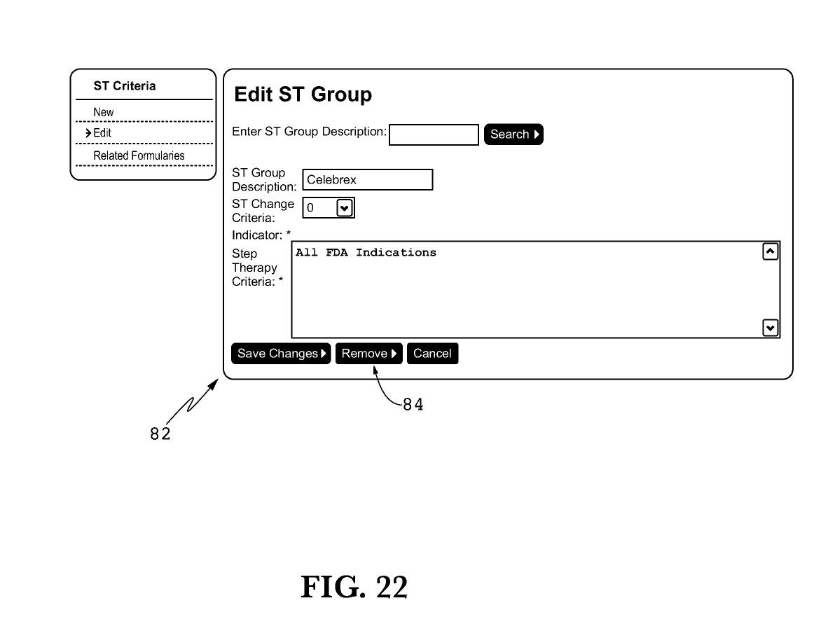

The system may also allow users to work with Step Therapy (ST) Groups during the HPMS Submission process. Referring to FIG. 21, a ST Group Search tab 80 of an example embodiment is shown. Using this tab, a user may search for different ST Groups. The system may also allow a user to create a new ST Group. Whether a user creates a new group or accesses an existing group, the user may have the ability to edit information regarding the group. Referring to FIG. 22, a sample Edit ST Group tab 82 according to an example embodiment is shown. This tab allows a user to change the ST Criteria Change Indicator and the ST Criteria. In different embodiments, additional information regarding a ST Group may be maintained by the system and editable by a user. The Edit ST Group tab 82 not only allows a user to edit, but also allows a user to delete, a ST Group from the system by selecting the Remove option 84.

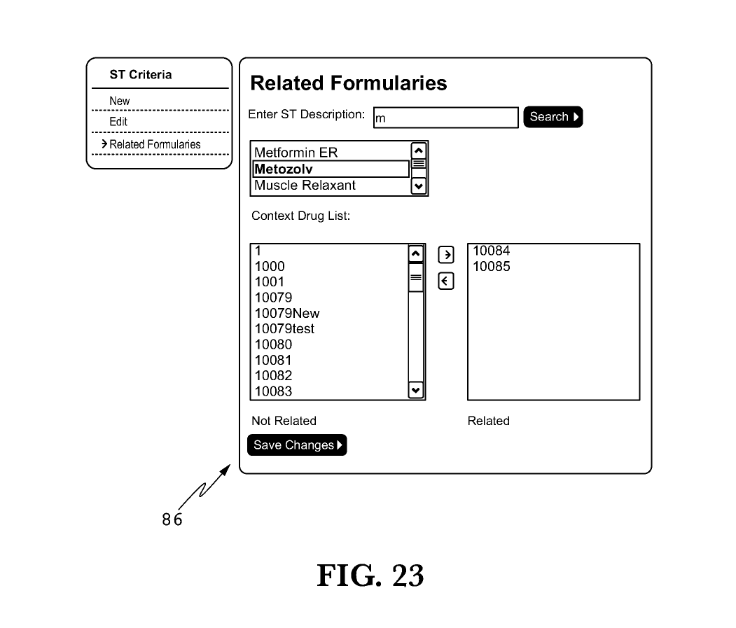

As with PA Groups, the relationship between ST Groups and formularies may be viewed by a user and updated. Referring to FIG. 23, a sample Related Formularies tab 86 according to an example embodiment is shown. This tab allows the user to view those formularies that are related and unrelated to a particular ST Group. This tab also allows the user to update the status of formularies and save the changes.

It may be necessary for the system to generate files (formulary, PA, and ST files) for a third party, such as CMS, so that the third party can review and approve the content of the files before the health benefits company begins dispensing medications to its members. Reports that are created for sending to a third party, such as CMS, may be reviewed and validated prior to submission to ensure that they meet submission requirements. For example, a submission requirement may be that for every formulary there are at least two drugs in each American Hospital Formulary Service (AHFS) category and class, and that at least one of the two drugs is in a preferred tier (1 or 2). The system may allow a user to generate a report validating the two drug requirement. Such a report may identify any AHFS category and class that violates the requirement, and may also offer recommendations as to which drugs on a FRF should be used in the formulary in order to resolve the issue. Another example of a validation report is one that verifies all drugs in classes of clinical concern (such as antidepressants or antipsychotics) have the proper PA or ST type. Yet another example of a validation report is one that verifies no non-allowable changes have been made to the formulary since the last approved version. Non-allowable changes could include deletion of drugs or increasing tiers.

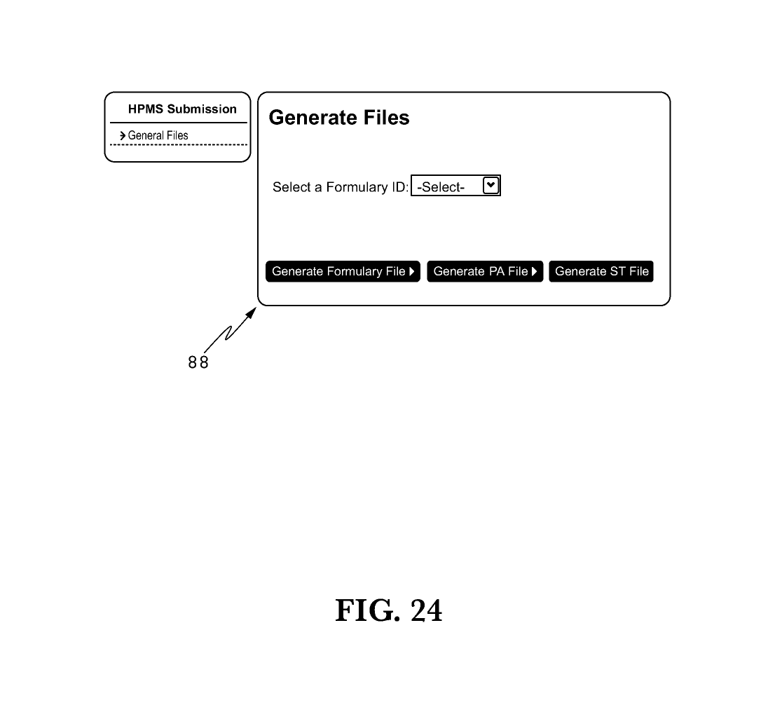

When it comes time to actually submit a report to CMS or another third party, the system allows a user to generate the files to be sent. Referring to FIG. 24, a sample Generate Files tab 88 of an exemplary embodiment is shown. This tab allows the user to select a formulary, and then generate three different types of files: a formulary file; a PA file; or a ST file. Once a formulary file, PA file, or ST file is generated, the system may assign the related formulary to a “in desk review” status or other status to indicate to system users that the file has been generated and is being submitted to CMS or another third party. Examples of the format and fields in an exported formulary file, PA file, and ST is provided in Appendix 2.0, Appendix 2.1, and Appendix 2.2, respectively.

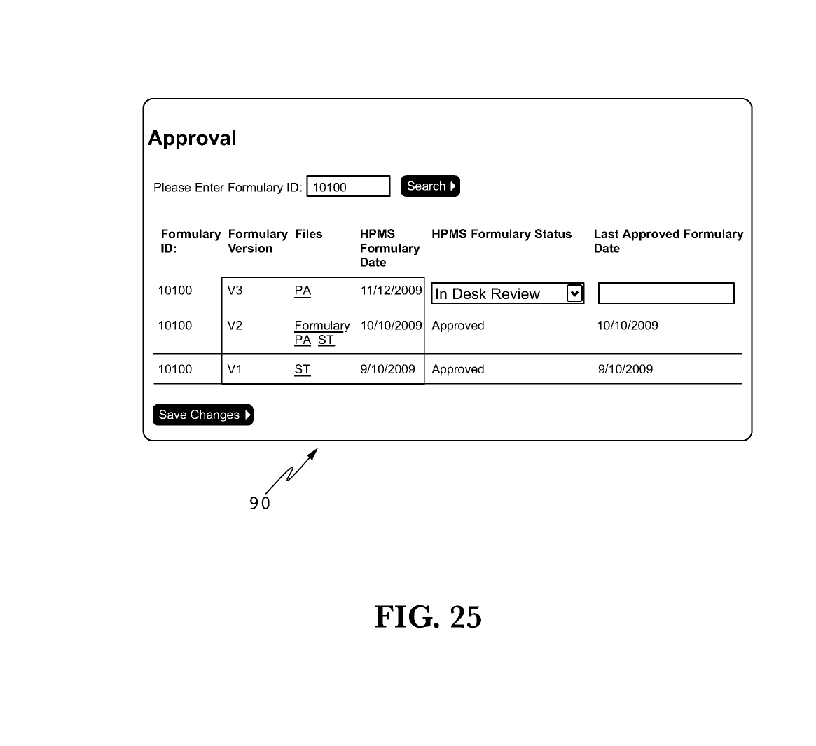

Once submitted, the system may allow a user to track the CMS approval process. Referring to FIG. 25, a sample Approval tab 90 of an exemplary embodiment is shown. A user may enter a formulary identifier to search the system for formularies that are either waiting approval or have been approved. The system may provide the user with information regarding the version of the formulary, the type of files (formulary, PA, or ST), formulary date, status, and last approved formulary date. Once approval by CMS has been communicated to the health benefits company, a user may change the HPMS Formulary Status from “in desk review” to “approved.” While in this embodiment the user changes the status to “Approved,” in other embodiments CMS may communicate approval through a live feed to the system, and the status is automatically updated by the system without user intervention. The system may use the formulary data in the latest approved version to generate reports and provide data feeds to CMS or other third parties.

A health benefits company may use data generated by the centralized formulary system to update a claims tracking database. The system may track data as claims are approved or denied at each stage. Data in the tracking database may include clinical sign-off information, formulary operations approval, and confirmation.

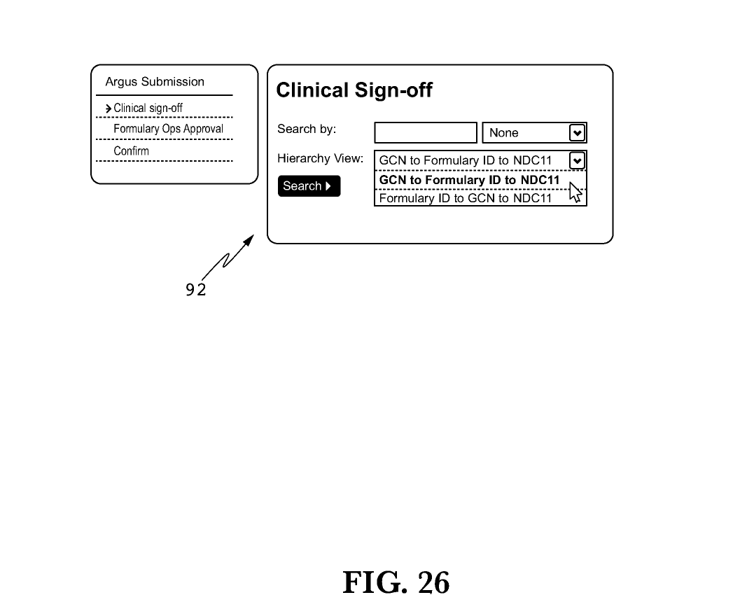

Referring to FIG. 26, a sample Clinical Sign-off tab 92 of an exemplary embodiment is shown. This tab may be accessed from the claims processor (Argus Submission) menu 24 on the home page 10. This tab 92 allows the user to search using different search options, including User identifier, GCN, NDC, or Formulary identifier. Different hierarchical views may be selected, including, for example, GCN to Formulary identifier to NDC 11, or Formulary identifier to GCN to NDC 11. The search results may be presented in a table that allows the user to perform an action for each level of records. For example, for each NDC 11 record, GCN record, and Formulary identifier record, the system may allow the user to either approve or deny. Records that are approved may then move to the next stage of the approval process, for example, they may be considered for formulary operations approval. If a user chooses to deny a record, the system may prompt the user to enter a reason for denial. Impacted drugs included on a denied record may remain in their last approved status. If there was no previous approval for a record, and the related formulary is closed, the system may set the record status to ‘not covered.’ If there was no previous approval for a record, and the related formulary is open, the system may set the record status to ‘covered.’

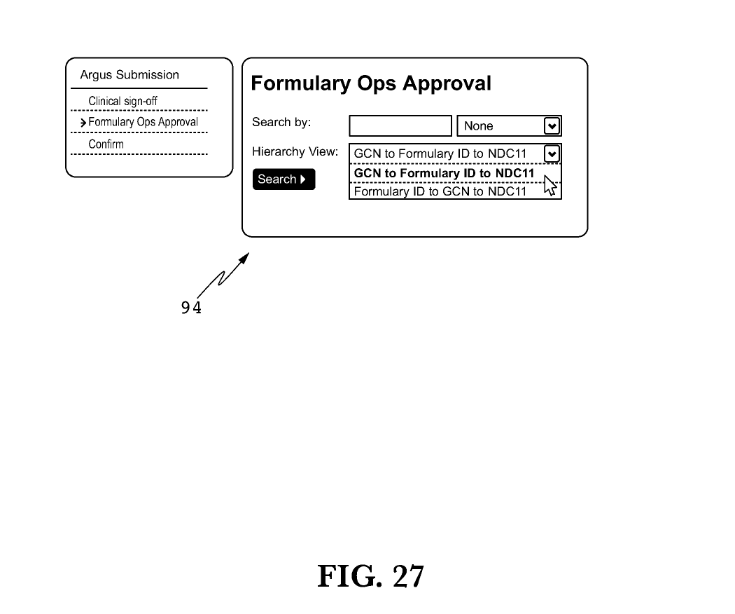

The formulary operations approval process may be similar to the Clinical Sign-Off approval process. Referring to FIG. 27, a sample formulary operations approval tab 94 of an example embodiment is shown. As with the Clinical Sign-Off tab 92, this tab 94 allows the user to search for records based on different criteria, and gives the user the ability to approve or deny the resulting records.

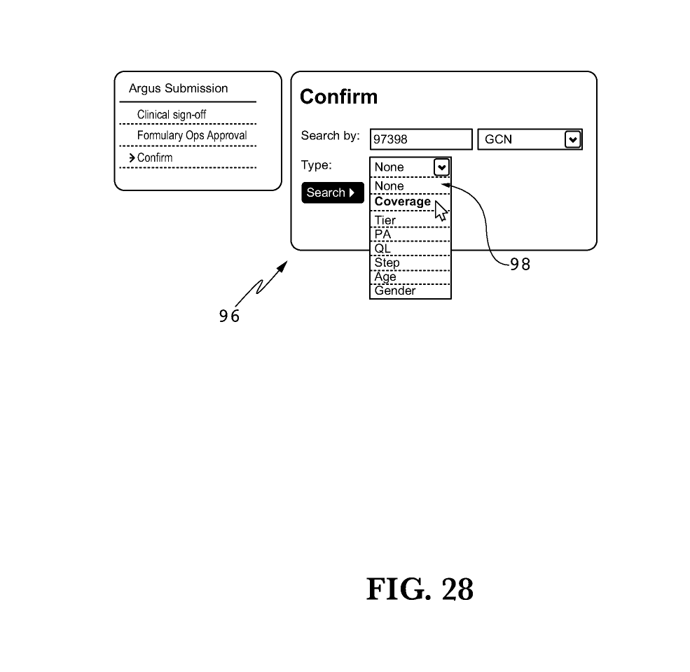

The last part of the submission process is to confirm the submission. Referring to FIG. 28, a sample Confirm tab 96 of an example embodiment is shown. Search criteria similar to those on the Clinical Sign-off tab 92 and Formulary Operations Approval tab 94 may be selected by the user. Also, a drop down type menu 98 may allow the user to search for updates of a particular type only. A search may be performed using all of the available search fields or just one or more. Once the user has selected search criteria and entered search terms, the results may be presented in a hierarchal view, for example, GCN (expandable) to Formulary identifier (expandable) to NDC 11.

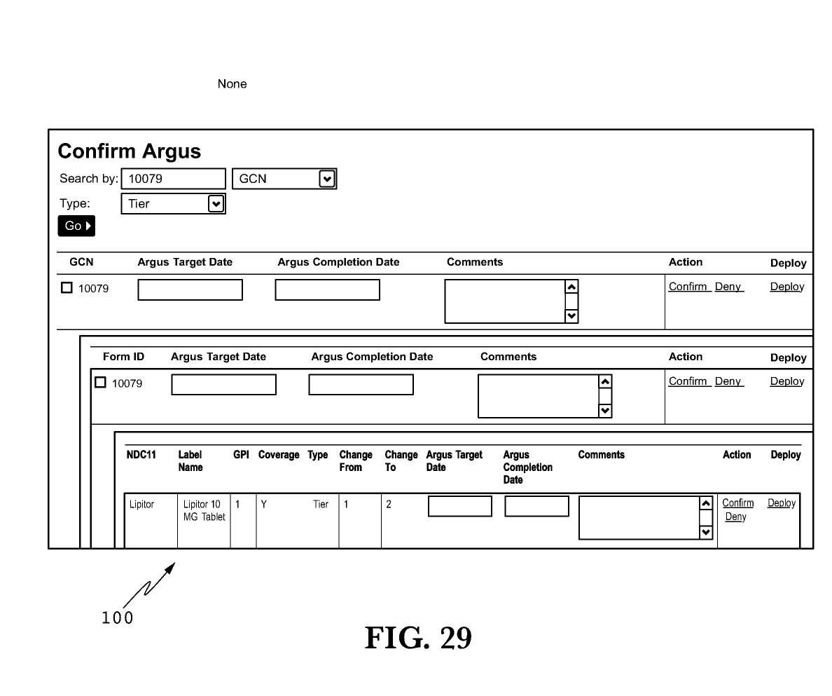

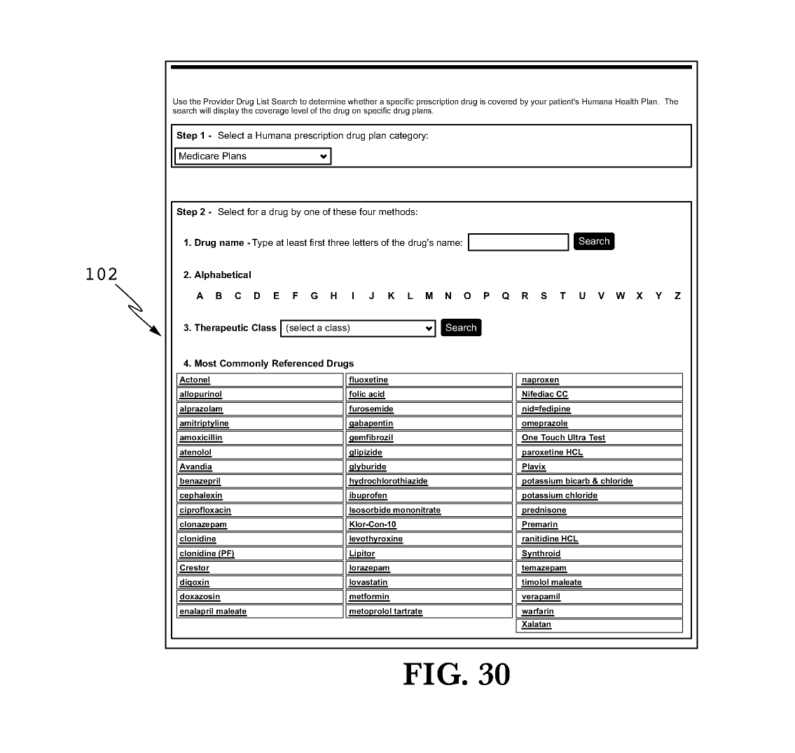

Referring to FIG. 29, a sample Confirm Results page 100 according to an example embodiment is shown. The search criteria entered in this particular example was 10079, GCN, and Tier. GCN and Formulary identifier levels may be expanded to reveal all levels down to the NDC. For each NDC level the following fields may be returned: NDC 11; Label Name; GPI; and Coverage. Additional information regarding each NDC may be present to show what changed on each record. In FIG. 29, the Lipitor record shows a tier value change from 1 to 2. If multiple changes have occurred to the same NDC, the Confirm Results page 100 may list each change as a separate record. As shown in FIG. 29, each level of the search results may provide the user with the same options for entering information regarding that record. The claims processor target date is the date that the user would like to get a deployment confirmation email from the claims processor. The claims processor completion date is the actual date the data was successfully deployed in the claims processor. Comments allow a user to explain why a row has been denied, if that action is taken. These are simply examples of information that may be recorded, and in different embodiments different types of information regarding each record may be recorded.

As shown in FIG. 29, each record allows the user to choose a certain action. Confirm may allow a user to save the record and change the record status to “confirmed.” The “deny” option may allow the user to clear the claims processor target Date or claims processor completion date fields, create a record of the cleared data for audit purposes, and allow the user to input new data. The “deploy” option sets the status of the record to “deployed”. This data can be subsequently tracked by generating a formulary deploy report. Once the claims processor has received and processed the data that has been deployed, a user can update the claims processor completion data fields. While in some embodiments a user may receive confirmation from the claims processor via emails, in some embodiments the claims processor may submit confirmation information to the system via a live feed, and the claims processor completion data fields may be updated automatically. For data that was not deployed, a user may enter the reason in the comments field and select the deny option.

The system may track drugs to ensure drug safety. For example, the system may track drugs to ensure that drugs are not repackaged, and are not obsolete. The point at which a drug is obsolete may be once the obsolete date is more than two years older than the current date. When a formulary's status is changed from inactive to active, the system may automatically remove NDCs that are no longer on the First Data Bank, have become a repackaged drug, have become obsolete, have switched to an over-the-counter indication, or met some other type of criteria that is monitored by the system. Logic that may be used by the system to identify NDCs that need to be removed is shown in Appendix 2.3.

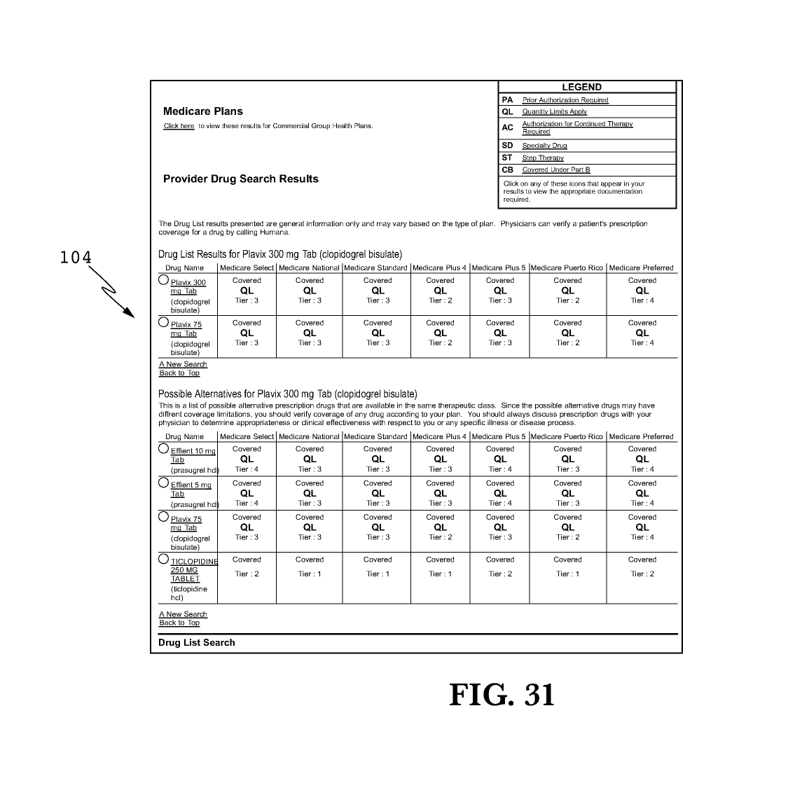

The system may provide an online drug list that can be accessed by a healthcare benefit company's member. Using the web, a member may select the type of health plan and select a particular drug to see whether that drug is covered by the health plan. Referring to FIG. 30, a sample online drug list search page 102 according to an example embodiment is shown. This page allows a user to select a drug plan category (for example, Medicare Plans) and then search for a drug either by name, alphabetically, or by therapeutic class. Referring to FIG. 31, a sample provider drug search results page 104 of an example embodiment is shown. The results shown on this page 104 are for the drug Plavix, and its coverage under different Medicare plans. Also shown are possible alternatives for Plavix. The system may run the online drug list by creating multiple web files for the Context Drug list, Formulary Information, Drug Information, Alternative Logic, and Conditions. The system may extract drug data for the online drug list on a periodic basis, such as once a week, and create multiple web files to support the online drug list application. Examples of data elements and rules for web files, including a Context drug list, formulary information, drug information, alternative logic, and condition, is shown in Appendices 2.4 through 2.8.

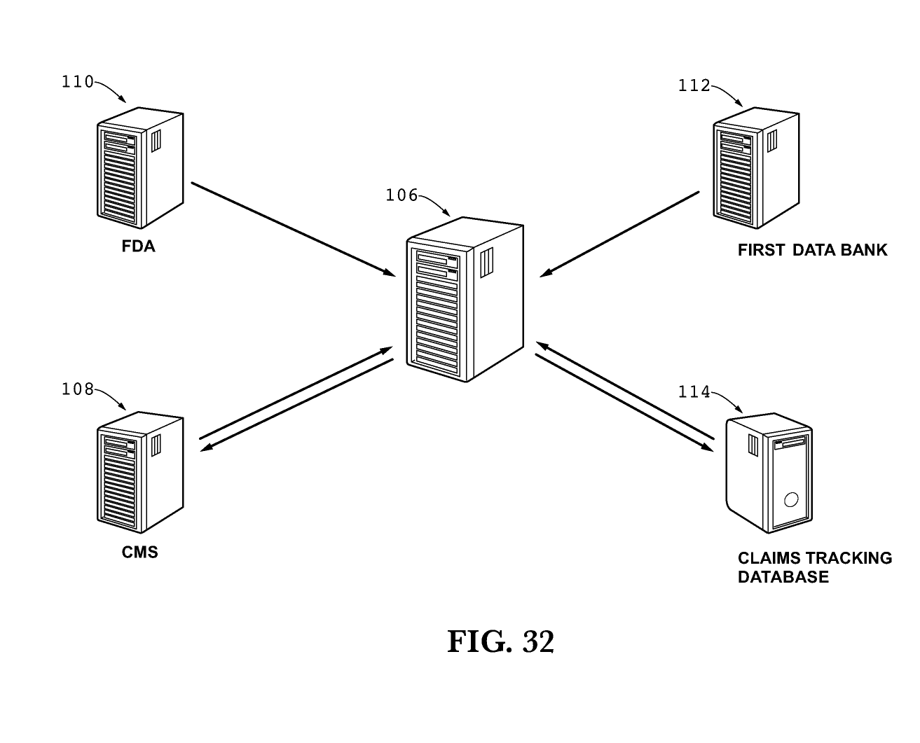

Referring to FIG. 32, a system and logic diagram of an exemplary embodiment is shown. In this system, a centralized formulary server 106 maintained by a healthcare benefits company contains a database for formulary data. The centralized formulary server 106 also maintains the on-line web portal for user groups associated with the healthcare benefits company to access and use formulary data as necessary. Multiple users may access the on-line web portal simultaneously, and user access to different type of formulary data and the ability to edit formulary data may be restricted depending on the user or user group. In some embodiments, any user trying to access the system must provide a user name and password. The centralized formulary server 106 also maintains the on-line drug list that is accessible via the internet to health care benefits member and/or the public at large. In some embodiments the on-line drug list may only be accessible to healthcare benefits company members who must enter a username and password in order to access the drug list.

The centralized formulary server 106 may receive data relative to drug formularies from one or more remote locations. The Centers for Medicare and Medicaid Services (CMS) server 108 may provide Formulary Reference Files (FRFs) to the centralized formulary server 106 over a secure network. FRF files may be received on a monthly basis or at a different frequency as needed. The CMS server 108 receives Health Plan Management System (HPMS) Submissions from the centralized formulary server 106 and also communicates to the centralized formulary server 106 when HPMS Submissions have been approved. A server 110 maintained by The Food and Drug Administration (FDA) provides data to the centralized formulary server 106 regarding the registry list.

Another remote source that the centralized formulary server receives data from is the First Data Bank server 112. This server 112 accesses the First Data Bank database and forwards National Drug Data Files (NDDFs) to the centralized formulary server 106. NDDFs include data regarding medication identifiers, drug descriptions, drug dosages, and form of dosages. The First Data Bank server 112 may provide data on a weekly basis or at another frequency as needed.

A claims tracking database 114 may be located remotely to the centralized formulary server 106. Formulary data is sent from the centralized formulary server 106 to the claims tracking database 114. Reports generated by the centralized formulary system 106 may also be sent to the claims tracking database 114 for e-Prescribing purposes. The claims tracking database 114 may send data to the centralized formulary server 106 as well, including Generic Product Identifier (GPI) override files.

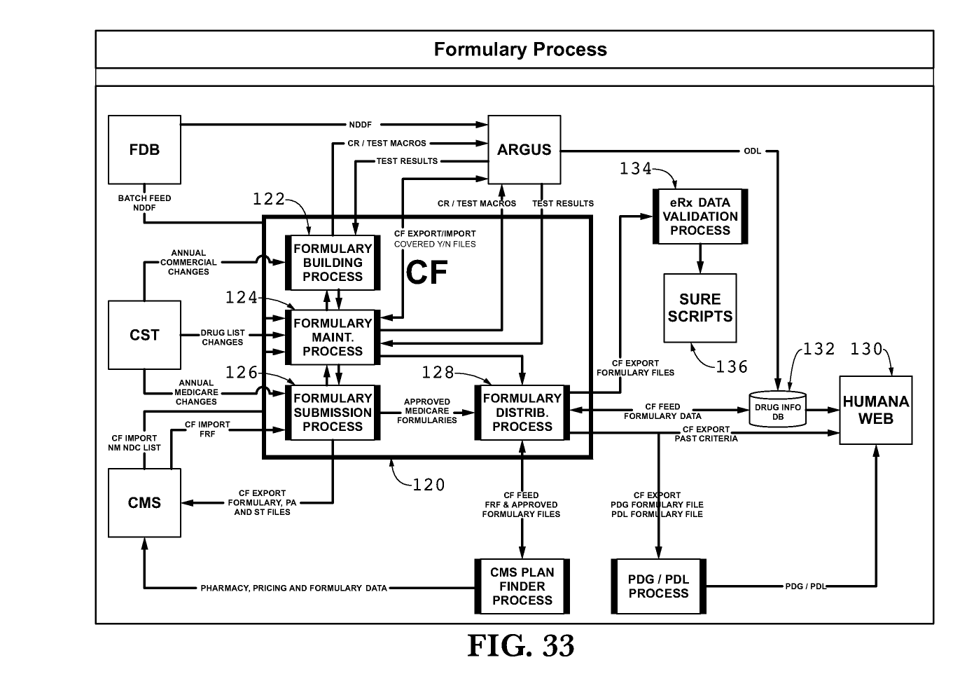

Referring to FIG. 33, a block diagram of a centralized formulary process according to an example embodiment is shown. In an example embodiment, a centralized formulary process 120 comprises a formulary build process 122, a formulary maintenance process 124, a formulary submission process 126, and a formulary distribution process 128. Centralized formulary input processes include the formulary build 122 and formulary maintenance 124 processes. The build process 122 supports creation and maintenance of formulary lists while the maintenance process 124 supports specific drug list changes. The submission process 126 provides functionality for developing and submitting formularies to CMS for approval. The distribution process 128 provides functionality for distributing formularies to lines of businesses, third party computer systems, etc. In one example, the formulary distribution process 128 supports a formulary data feed to a drug database 132 that supports a web application 130 for viewing information about the drugs on the formulary. The feed provides current formulary data for the drug database which may have pricing and other data relevant to a health plan. A user at the web site may view data from the formulary to determine drug coverage. The formulary distribution process 128 may also provide file export functionality to provide formulary files for a prescription validation 134 and e-prescription processing 138. The distribution process may be modified as needed to ensure that current formulary data is distributed throughout an organization according to the specific needs of multiple lines of business.

While certain embodiments of the present invention are described in detail above, the scope of the invention is not to be considered limited by such disclosure, and modifications are possible without departing from the spirit of the invention as evidenced by the claims. One skilled in the art would recognize that such modifications are possible without departing from the scope of the claimed invention.

### APPENDICES

APPENDIX 1.0
Example of Searchable Fields on Drug Search Tab

| Field Name | Type and Maximum Length |
|---|---|
| Drug Name | 20 alphanumeric characters |
| NDC | 11 numeric characters, system can search with |
| | only 9 |
| RXCUI | 6 numeric characters |
| GCN | 5 numeric characters, exact match only |
| Status | Pending, Clinical Sign-off, Approved, Confirmed |
| Tier | 0, 1, 2, 3, 4, 5, 6 |
| Prior Authorization | 0, 1, 2, 3 |
| Argus GPI | 0, 1, 2, 3 |
| Quantity Limits | 4 numeric characters |
| Step Therapy Step | 0, 1, 2 |
| Value 1 | |
| Step Group 1 | Pop box of ST Groups linked to the selected |
| | formulary |
| Step Therapy Step | 0, 1, 2 |
| Value 2 | |
| Step Group 2 | Pop up box of ST Groups linked to the selected |
| | formulary |
| PA Group | Pop up box of available PA Group descriptions |
| Hierarchy View | None, STC, GCN, MedID |
| Gender Edits | M, F |
| Age Edits | Yes/No Returns records with data in the Age Edit |
| | field |
| Proxy View only | Check box |

APPENDIX 1.1
Example of Fields for Search Results at GCN Level

| Field Name | Type and Maximum Length |
|---|---|
| Formulary ID | |
| GCN | |
| Covered | Y or N |
| Tier | 1, 2, 3, 4, 5, 6 |
| PA | 0, 1, 2, 3 |
| PA Group | Pop up box of PA Groups linked to the selected |
| | formulary - Changes trigger |
| | a status change to Pending. |
| QL | Y or -If Y, QL Amt and QL DS become required |
| | fields. |
| QL Amt | 4 characters |
| QL DS | 10 characters |
| QL Dacon | 6 characters |
| Step Therapy Type | |
| Step Preclusive | Y or N |
| Step Therapy Value 1 | 0, 1, 2 |
| Step Therapy Group 1 | Pop up box of ST Groups linked to the selected |
| | formulary - Changes trigger |
| | a status change to Pending. |
| Step Therapy Value 2 | 0, 1, 2 |
| Step Therapy Group 2 | Pop up box of ST Groups linked to the selected |
| | formulary - Changes trigger |
| | a status change Pending. |
| Age Min. | 10 characters |
| Age Max | 10 characters |
| Gender | M or F |
| GPI | |
| GI | |
| Status | |
| Action | |

APPENDIX 1.2
Example of Fields for Search Results at NDC Level

| Field Name | Type and Maximum Length |
|---|---|
| Formulary ID | |
| NDC 11 | |
| Drug Name | |
| Label Name | |
| Covered | Y or N |
| Tier | 1, 2, 3, 4, 5, 6 |
| PA | 0, 1, 2, 3 |
| PA Group | Pop up box of PA Groups linked to the selected |
| | formulary - Changes trigger |
| | a status change to Pending. |
| QL | Y or -If Y, QL Amt and QL DS become required |
| | fields. |
| QL Amt | 4 characters |
| QL DS | 10 characters |
| QL Dacon | 6 characters |
| Step Therapy Type | |
| Step Preclusive | Y or N |
| Step Therapy Value 1 | 0, 1, 2 |
| Step Therapy Group 1 | Pop up box of ST Groups linked to the selected |
| | formulary - Changes trigger |
| | a status change to Pending. |
| Step Therapy Value 2 | 0, 1, 2 |
| Step Therapy Group 2 | Pop up box of ST Groups linked to the selected |
| | formulary - Changes trigger |
| | a status change to Pending. |
| Age Min. | 10 characters |
| Age Max | |
| Gender | M or F |
| GPI | |
| GI | |
| Status | |
| Action | |

APPENDIX 1.3
Example of Fields for Search Results at STC Level

| Field Name | Type and Maximum Length |
|---|---|
| Formulary ID | |
| STC | |
| Covered | Y or N |
| Tier | 1, 2, 3, 4, 5, 6 |
| PA | 0, 1, 2, 3 |
| PA Group | Pop up box of PA Groups linked to the selected |
| | formulary - Changes trigger |
| | a status change to Pending. |
| QL | Y or -If Y, QL Amt and QL DS become required |
| | fields. |
| QL Amt | 4 characters |
| QL DS | 10 characters |
| QL Dacon | 6 characters |
| Step Therapy Type | |
| Step Preclusive | Y or N |
| Step Therapy Value 1 | 0, 1, 2 |
| Step Therapy Group 1 | Pop up box of ST Groups linked to the selected |
| | formulary - Changes trigger |
| | a status change to Pending. |
| Step Therapy Value 2 | 0, 1, 2 |
| Step Therapy Group 2 | Pop up box of ST Groups linked to the selected |
| | formulary - Changes trigger |
| | a status change Pending. |
| Age Min. | 10 characters |
| Age Max | |
| Gender | M or F |
| GPI | |
| GI | |
| Status | |
| Action | |

APPENDIX 1.4
Example of Fields for a New Formulary page

| Field Name | Allows . . . |
|---|---|
| Formulary ID | You to create a 10 alphanumeric character ID |
| Formulary Name | You to create a 40 alphanumeric character name |
| Formulary Status | Active, Inactive |
| | Note: Formularies with an aActive status are |
| | maintained with batch FDB updates. |
| Formulary Format | CY 2009, CY 2010, CY 2011, Commercial |
| # of tiers | 0, 1, 2, 3, 4, 5, 6 |
| Line of Business | Medicare, Commercial, Medicaid |
| Type | Open, Closed |
| | Note: Defaults to Open. All drugs in an open |
| | formulary are covered. All drugs in a closed |
| | formulary are not covered. However, these open |
| | and closed formularies can have a drug's status |
| | overridden by Include and Exclude Context Drug |
| | Lists. |
| Description | You to type 256 alphanumeric characters |
| Created Date | System generated |
| Created By | System generated |
| Copied From | You to type a 10 alphanumeric character name or |
| | ID. |
| Argus Formulary | You to create a 10 alphanumeric character ID. |

APPENDIX 1.5
Example of fields for an Import Formulary page

| Field Name | Allows . . . |
|---|---|
| Formulary ID | You to create a 10 alphanumeric character ID |
| Formulary Name | You to create a 40 alphanumeric character name. |
| Formulary Status | Active, Inactive |
| Formulary Format | CY 2009, CY 2010, CY 2011, Commercial |
| # of tiers | 0, 1, 2, 3, 4, 5, 6 |
| Line of Business* | Medicare, Commercial, Medicaid |
| Type | Open, Closed |
| | Note: Defaults to Open. All drugs in an Open |
| | formulary are covered. All drugs in a Close |
| | Formulary are not. |
| Argus Formulary ID | You to create a 10 alphanumeric character ID. |
| Browse to import file | You to click Browse, select the formulary text file |
| | you want to upload, and click Go. |

APPENDIX 1.6
Example of Fields that Are Uploaded When a Formulary is Imported

| | Max. | | |
|---|---|---|---|
| Field Name | Length | Description | Sample Value(s) |
| NDC | 11 | National Drug Category Number | 00123476546 |
| RXCUI | 8 | RxNorm identifier from the active | 210597 |
| | | Formulary Reference File. | |
| Coverage Status/Cvg/ | 1 | Indicates whether the NDC is covered | Y |
| Covered | | in the formulary. | N |
| | 2 | Defines the Cost Share Tier Level | 1 = Tier Level 1 |
| | | associated with the drug. | 2 = Tier Level 2 |
| | | Note: Assumes each drug is assigned | 3 - Tier Level 3 |
| | | to only one tier value. | 4 = Tier Level 4 |
| | | | 5 = Tier Level 5 |
| | | | 6 = Tier Level 6 |
| Drug Type Label | 1 | Indicates the drug's type label. | 1 = Generic |
| | | From the list of labels (right), enter the | 2 = Preferred Generic |
| | | label value for the Drug Type. | 3 = Non-Preferred |
| | | | Generic |
| | | | 4 = Brand |
| | | | 5 = Preferred Brand |
| | | | 6 = Non-Preferred |
| | | | Brand |
| Quantity Limits/QL YN | 1 | Does the drug have a quantity limit | 0 = No Quantity limits |
| | | restriction? | 1 = Quantity Limits |
| | | | Apply |
| Quantity Limit Amount/ | 7 | If the Quantity Limit is 1, type | 9 grams |
| QL Amt | | the quantity limit unit amount for | |
| | | a given Rx or time period. | |
| | | These units must be defined by | |
| | | a unit of measure such as: | |
| | | number of tablets, millimeters, | |
| | | grams and so on. | |
| | | If the Quantity Limit is 0, leave | |
| | | this field blank. | |
| | | The maximum number of decimal points | |
| | | accepted is 5. | |
| | | Example | |
| | | 9.99999 | |
| Quantity Limit Days/QL | 3 | The number of days associated with the | |
| DS | | quantity limit. The maximum number | |
| | | accepted is 999. | |
| | | Exception | |
| | | If the Quantity Limit field is 0, leave this | |
| | | field blank. | |
| Prior Authorization Type | 1 | Is prior authorization required for the | 0 = No Prior |
| (PA) | | drug? | Authorization |
| | | | 1 = Prior |
| | | | Authorization Applies |
| | | | 2 = Prior |
| | | | Authorization Applies |
| | | | to New Stats Only |
| | | | 3 = Part B vs. Part D |
| | | | Prior Authorization |
| | | | Only |
| Prior Authorization | 100 | Description of the drug's prior | Antiemetics |
| Group Desc/Group/PA | | authorization group as it will appear on | |
| Group | | the submitted prior authorization | |
| | | attachment. The group name may | |
| | | represent a drug category, class, or (if | |
| | | no other grouping structure applies) | |
| | | may simply be the name of the drug. | |
| | | If the Prior Authorization Type is 0 or 3, | |
| | | then this field is blank. | |
| Limited Access? | 1 | Is access to this drug limited to certain | 1 = Yes |
| | | pharmacies? | 0 = No |
| Therapeutic Category | 100 | Name of the drug's Category. | Analgesics |
| Name | | | |
| Therapeutic Class | 100 | Name of the drug's Class | Opioid analgesics |
| Name | | | |
| QL Decon | 4 | A Quantity Limit Average Daily | Examples |
| | | Consumption applies to oral tablets or | 30/30 is equal to 1 |
| | | capsules and promotes cost-efficient | cap per 1 day, 1 cap |
| | | regimens for drugs dosed once daily | divided by .75 = 1.3 |
| | | when multiple strengths are similarly | or Dacon of 1.333 |
| | | priced | 60/30 is equal to 2 |
| | | | caps per 1 day, 2 |
| | | | caps divided by .75 = |
| | | | 2.6 or Decon of 2.666 |
| Step Therapy Type/s | 1 | Does step therapy apply to this drug? | 0 = Not Part of a Step |
| ST | | Note: Prerequisite (Step 1) drugs also | Therapy Program |
| | | have a value of 1 in this field. | 1 = Step Therapy |
| | | | Applies |
| | | | 2 = Step Therapy |
| | | | Applies to New Starts |
| Step Preclusive | | Preclusive step therapy excludes the | |
| | | use of a drug or drug class when | |
| | | therapy is contraindicated with another | |
| | | drug or drug class. It can be used to | |
| | | develop customized drug/drug | |
| | | interaction edits or duplicate therapy | |
| | | edits. | |
| Step Therapy Total | 2 | The total number of step therapy drug- | 3 |
| Groups/Step Group 1 | | treatment groups in which the drug is | |
| | | included. The maximum number | |
| | | accepted is 99. | |
| | | If the Step Therapy Type is 0, then this | |
| | | field is bank. | |
| Step Therapy Group | 100 | Description of the step therapy drug | CHF Therapy |
| Desc | | treatment group. | Angina Therapy |
| | | If the Step Therapy Type is 0, this field | CVD Therapy |
| | | should be blank. | |
| | | Note: For a given RXCUI, each ST | |
| | | Group Description must be unique. | |
| Step Therapy Step | 2 | Identifies the step number or level | 4 |
| Value/ST step value 1/ | | within the sequence for the Step | Example |
| value 2 | | Therapy Group. The range of accepted | Step 4 of 6 |
| | | values is 1 to 99. | |
| | | This field is repeated in the record | 1 |
| | | (based on the numerical value in the | Example |
| | | Step Therapy Total Groups field) and in | Step 1 of 3 |
| | | the same order as the list of values | |
| | | given for the Step Therapy Group Desc | |
| | | field. | |
| | | If the Step Therapy Type is 0, this field | 5 |
| | | is blank. | Example |
| | | | Step 5 of 5 |
| GPI | 1 | A Generic Product Identifier labels a | 1 = Generic |
| | | drug either generic or brand | 2 = Brand |
| GI | 1 | A Generic Indicator indicates a drug's | 1 = Multi-source |
| | | number of manufactures. For example, | product |
| | | brand drugs are normally from a single | 2 = Single-source |
| | | manufacturer while generic drugs are | product |
| | | often manufactured by several | |
| | | companies. | |

APPENDIX 1.7
Example of Fields and Field Criteria for New Context Drug List

| Field Name | Allows . . . |
|---|---|
| Context Drug List | You to create a 30 alphanumeric character ID. |
| Name | |
| Purpose/Type | Informational (Info List), B/G, Include, Exclude |
| | If you select Info List, CF displays its Secondary |
| | Info Type drop-down. Selecting one of its values is |
| | optional: |
| | Maintenance Coverage in the Gap |
| | Abbreviated Drug Guide |
| | Printable Drug List |
| | Home Infusion Coverage in the Gap |
| | Diabetes Coverage in the Gap |
| | Preferred Diabetic Supplies |
| | Non-Preferred Diabetic Supplies |
| | ED |
| | Benzo/Barb |
| | ED/BB |
| | Specialty Drug |
| Description | You to type 255 alphanumeric characters. |
| Argus Drug List ID | Not in use at this time. |

APPENDIX 1.8
Exemplary Format of Export Prescription Drug Guide

| | | | | Business |
|---|---|---|---|---|
| | | | Sample Field | Rules/Reference |
| Field Name | Field type | Field Description | Value(s) | Sources |
| Formulary ID | CHAR | 5-Digit HPMS | 10079-Puerto Rico | A formulary ID |
| | | Formulary ID | 10080- Value | must be on every |
| | | | 10091 - Standard | drug on a |
| | | | 10082 - National | formulary |
| | | | 10084 - Plus | |
| | | | 10085 - Select | |
| Proxy NDC | CHAR | 11-digit National | 000003338000 | Convert RxCUI to |
| | | Drug Code | | Related NDC |
| | | | | using the FRF. |
| Drug Name | CHAR | Name of drug: | JANUVIA | Since FRF does |
| | | Brand = CAPS | Acarbose | not have drug |
| | | Generic = lower | | names, use BM |
| | | case | | field from First |
| | | | | Data Bank (FDB). |
| | | | | Also, use the |
| | | | | Generic Pricing |
| | | | | Indicator (GPI) to |
| | | | | capitalize brand |
| | | | | drug names. |
| Strength | CHAR | Strength of drug | 10 MG | Since FRF does |
| | | listed | | not have Strength, |
| | | | | use Argus FRF. |
| Dosage Form | CHAR | Drug form | Tablet | Since FRF does |
| | | | | not have Dosage, |
| | | | | use Argus FRF. |
| HIDO Value | CHAR | SNIP plan | D = diabetes | D = Reference |
| | | indicator | H = Home Infusion | Diabetes Context |
| | | | M = Maintenance | List |
| | | | GC = Gap | H = Ref. Home |
| | | | Coverage | Infusion Context |
| | | | NM = Non Mail- | List |
| | | | Order | M = Ref. |
| | | | | Maintenance Meds |
| | | | | Context Drug List |
| | | | | GC = All tier 1 |
| | | | | drugs for 10082, |
| | | | | 10084, and 10085 |
| | | | | NM = Ref. Non |
| | | | | Mail Context List |
| Tier Level | CHAR | Defines the cost | 1 = Tier Level 1 | Use Formulary File |
| | | share tier level | 2 = Tier Level 2 | to get Tier data. |
| | | associated with | 3 = Tier Level 3 | |
| | | the drug | 4 = Tier Level 4 | |
| UMR | CHAR | Utilization | PA = Prior | Use Formulary File |
| | | Management | Authorization | to pull in UMR: |
| | | Requirements | QL = Quantity | QL = Applies only |
| | | | Limit | to 1 |
| | | | ST = Step Therapy | PA = Applies to 1, |
| | | | | 2, and 3 |
| | | | | ST = Applies to 2 |
| | | | | and 3 on ST Value |
| Therapeutic Class | CHAR | Therapeutic class | Antipsychotic | Use Formulary File |
| | | drugs fall in | Agents | to pull in: |
| | | | | Therapeutic Class |
| | | | | (AHFS) |
| Language | CHAR | Language data is | English | |
| | | in | Spanish | |
| Abbreviated Drug | CHAR | Drug Guide | A = Abbreviated | Use FRF to |
| Guide | | Indicator | C = | reference PDG |
| | | | Comprehensive | Indicator |

APPENDIX 1.9
Example of FDB Reports

| FDB Report Name | This report tracks . . . | List of Fields on this Report |
|---|---|---|
| Argus GPI Change | Generic Product Identifier | GCN |
| Report | changes on the Argus | NDC |
| | GPI override file. CF | Label Name |
| | automatically imports the | Old GPI |
| | Argus GPI override file weekly. | New GPI |
| Deleted NDC Report | NDCs not part of the active drug | |
| | universe- | |
| | NDCs removed from the | |
| | formulary. | |
| GI Change Report | New Generic Indicators listed for | GCN |
| | NDCs on the | NDC |
| | FDB NDDF. | Label Name |
| | | Old GI |
| | | New GI |
| Max Dose Change Report | Changes to Adult Max Daily | GCN |
| | Dose for an NDC on the FDB | NDC |
| | NDDF | Label name |
| | | Old Adult Max Daily Dose |
| | | Old Adult Max Daily Dosage |
| | | Form |
| | | Old Adult Max Daily Unit Quantity |
| | | Old Adult Max Daily Unit Size |
| | | New Adult Max Daily Dose |
| | | New Adult Max Daily Dosage |
| | | Form |
| | | New Adult Max Daily Unit |
| | | Quantity |
| | | New Adult Max Daily Unit Size |
| New GCN Report | New GCNs added to the FDB | GCN |
| | NDDF. | NDC |
| | | Label name |
| | | MFG ID |
| | | GI |
| | | GPI |
| | | Route |
| | | Dosage |
| New NDC Report | New NDCs added to the FDB | GCN |
| | NDDF, which are | NDC |
| | not assigned to a related | Label Name |
| | GCN/MedID. | GI |
| | | GPI |
| New STC Report | New STCs added to the FDB | STC Code |
| | NDDF | STC Description |
| Price Change Report | WAC price changes by NDC on | |
| | the FDB NDDF. | |
| Reclassification | FDB changes is made- | New GCN |
| Report | regardless of any change | Old GCN |
| | in CF. | NDC |
| | Examples: | Old STC |
| | NDCs reclassified into a new | New STC |
| | GCN on the FDB | Label Name |
| | NDDF. | GI |
| | NDC was in GCN 12345 is now | GPI |
| | in GCN 12346. | |

APPENDIX 2.0
Example of Formulary File Format and Fields

| | | Max. | | |
|---|---|---|---|---|
| Field Name | Field Type | Length | Description | Sample Value(s) |
| RXCUI | NUMBER required | 8 Max | RxNorm concept unique | 210597 |
| | | | identifier from the active | |
| | | | Formulary Reference File. | |
| Tier | CHAR Required | 2 | Defines the Cost Share Tier | 1 = Tier Level 1 |
| | | | Level Associated with the | 2 = Tier Level 2 |
| | | | drug. | 3 = Tier Level 3 |
| | | | Note: Assumes each drug | 4 = Tier Level 4 |
| | | | is assigned to only one tier | 5 = Tier Level 5 |
| | | | value. | 6 = Tier Level 6 |
| Drug Type | CHAR Required | 1 | Indicates the drug's type | 1 = Generic |
| Label | | | label. | 2 = Preferred |
| | | | | Generic |
| | | | | 3 = Non-Preferred |
| | | | | Generic |
| | | | | 4 = Brand |
| | | | | 5 = Preferred Brand |
| | | | | 6 = Non-Preferred |
| | | | | Brand |
| Quantity Limits | CHAR Required | 1 | Does the drug have a | 0 = No Quantity |
| | | | quantity limit restriction? | Limits |
| | | | | 1 = Quantity Limits |
| | | | | Apply |
| Quantity Limit | NUM Sometimes | 7 | If the Quantity Limit is 1, | 9.99999 grams |
| Amount | Required | | type the quantity limit unit | |
| | | | amount for a given Rx or | |
| | | | time period. These units | |
| | | | must be defined by a unit of | |
| | | | measure such as: number | |
| | | | of tablets, milliliters, grams | |
| | | | and so on. | |
| | | | If the Quantity Limit is 0, | |
| | | | this field is blank. | |
| | | | The maximum number of | |
| | | | decimal points accepted is | |
| | | | 5. | |
| Quantity Limit | NUM Sometimes | 3 | The number of days | 9 tablets every 60 |
| Days | required | | associated with the quantity | days |
| | | | limit. The maximum | |
| | | | number accepted is 999. | |
| | | | Exception: If the Quantity | |
| | | | Limit field is 0, leave this | |
| | | | field blank. | |
| Prior | CHAR Required | 1 | Is prior authorization | 0 = No Prior |
| Authorization | | | required for the drug? | Authorization |
| Type | | | | 1 = Prior |
| | | | | Authorization |
| | | | | 2 = Prior |
| | | | | Authorization |
| | | | | Applies to New |
| | | | | Starts Only |
| | | | | 3 = Part B vs. Part |
| | | | | D Prior |
| | | | | Authorization Only |
| Prior | CHAR Sometimes | 100 | Description of the drug's | Antiemetics |
| Authorization | Required | | prior authorization group as | |
| Group Desc | | | it will appear on the | |
| | | | submitted prior | |
| | | | authorization attachment. | |
| | | | The group name may | |
| | | | represent a drug category, | |
| | | | class, or (if no other | |
| | | | grouping structure applies) | |
| | | | may simply be the name o | |
| | | | the drug. | |
| | | | Exception: if response to | |
| | | | Prior Authorization Type is | |
| | | | 0 or 3, then leave this field | |
| | | | blank. | |
| Limited | CHAR Required | 1 | Is access to this drug | 1 = yes |
| Access? | | | limited to certain | 0 = No |
| | | | pharmacies? | |
| Therapeutic | CHAR Required | 100 | Enter the name of the | Analgesics |
| Category Name | | | category for the drug. | |
| Therapeutic | CHAR Required | 100 | Enter the name of the class | Opioid Analgesics |
| Class Name | | | for the drug. | |
| Step Therapy | CHAR Required | 1 | Does step therapy apply to | 0 = Not Part of a |
| Type | | | this drug? | Step Therapy |
| | | | Note: Prerequisite (Step 1) | Program |
| | | | drugs should also have a | 1 = Step Therapy |
| | | | value of 1 in this field. | Applies |
| | | | | 2 = Step Therapy |
| | | | | Applies to New |
| | | | | Starts |
| Step Therapy | NUM Sometimes | 2 | The total number of step | 3 |
| Total Groups | Required | | therapy drug-treatment | |
| | | | groups in which the drug is | |
| | | | included. The maximum | |
| | | | number accepted is 99. | |
| | | | If the Step therapy Type is | |
| | | | 0, then this field is blank. | |
| | | | Note: the last two fields | |
| | | | should be repeated in the | |
| | | | record - based on the value | |
| | | | in the Step Therapy Total | |
| | | | Groups field. | |
| Step Therapy | CHAR Sometimes | 100 | Description of the step | CHF Therapy |
| Group Desc | Required | | therapy drug treatment | Angina Therapy |
| | | | group. | CVD Therapy |
| | | | If the Step Therapy Type is | |
| | | | 0, this field should be blank. | |
| | | | Note: For a given RXCUI, | |
| | | | each ST Group Description | |
| | | | must be unique | |
| Step Therapy | NUM Sometimes | 2 | Identifies the step number | 4 |
| Step Value | Required | | or level within the sequence | Example |
| | | | for the Step Therapy | Step 4 of 6 |
| | | | Group. The range of | |
| | | | accepted values is 1 to 99. | |
| | | | This field is repeated in the | 1 |
| | | | record (based on the | Example |
| | | | numerical value in the Step | Step 1 of 3 |
| | | | Therapy Total Groups field) | |
| | | | and in the same order as | |
| | | | the list of values given for | |
| | | | the Step Therapy Group | |
| | | | Desc field. | |
| | | | If the Step Therapy Type is | 5 |
| | | | 0, this field is blank. | Example |
| | | | | Step 5 of 5 |

APPENDIX 2.1
Example of Fields for PA Group File

| | | Max. | |
|---|---|---|---|
| Field Name | Field Type | Length | Description |
| PA Group Desc | CHAR Required | 100 | Describes the prior authorization group-as it appears |
| | | | on the submitted formulary file. This field must exactly |
| | | | match the value in the Prior Authorization Group Desc |
| | | | field in the CF-generated and submitted formulary file. |
| PA Criteria | CHAR Required | 1 (0 or 1) | 0 = The PA criteria content did not change for this |
| Change | | | group description, compared to CY 2009. 1 = The |
| Indicator | | | description is new or the criteria content changed (for |
| | | | example, additional restrictions). |
| Covered Uses | CHAR Required | 3000 | Includes the FDA-approved and off-label indications |
| | | | for which the drug(s) will be covered. At a minimum, |
| | | | “All FDA-approved indications not otherwise excluded |
| | | | from Part D.” If the PA will be approved for all non- |
| | | | excluded off-label uses, in addition to the labeled |
| | | | indications, “All medically accepted indications not |
| | | | otherwise excluded from Part D” is included. If only |
| | | | certain off-label uses will be approved by prior |
| | | | authorization, the specific uses will be listed following |
| | | | this statement: “All FDA-approved indications not |
| | | | otherwise excluded from Part D”. |
| Exclusion | CHAR If | 2000 | Describes any criteria, for example, co morbid |
| Criteria | applicable | | diseases, laboratory data and so on, which will result |
| | | | in the exclusion of coverage for a member. |
| Required | CHAR | 2000 | Laboratory, diagnostic, or other medical information |
| Medical | If applicable | | required for initiation or continuation of the drug(s). |
| Information | | | |
| Age | CHAR | 500 | Age limitations or restrictions required for prior |
| Restrictions | If applicable | | authorization approval. |
| Prescriber | CHAR | 500 | Describes the prescriber attribute/s necessary for a |
| Restrictions | If applicable | | PA to be |
| | | | considered. |
| | | | Examples |
| | | | Specialist in a field |
| | | | Registered under a certain program |
| Coverage | CHAR | 100 | Duration for which the prior authorization will be |
| Duration | Required | | approved. |
| Other Criteria | CHAR | 3000 | Describes any other relevant criteria that cannot be |
| | If applicable | | otherwise classified into another field. |

APPENDIX 2.2
Example of Data Fields for ST Files

| | | Maxi- | |
|---|---|---|---|
| Field | | mum | |
| Name | Field Type | Length | Description |
| Step | CHAR | 100 | Describes the step therapy group as it |
| Therapy | Always | | appears on the submitted formulary |
| Group | Required | | file. This field must be an exact match |
| Desc | | | of the value entered in the Step |
| | | | Therapy Group Desc field on the CF- |
| | | | generated and submitted formulary file. |
| | | | Note: For each Step Therapy Group |
| | | | Description, there must be an RxCUI |
| | | | with a Step Therapy Value equal to 1. |
| Step | CHAR | 4000 | Describes the criteria of the step |
| Therapy | Always | | therapy drug. |
| Criteria | Required | | |

### Appendix 2.3

### Example of Logic for Maintaining Active Drug Formularies

The system may assign values to new NDCs based on these rules:
If all values of all NDCs in a GCN match, assign a new NDC to the related GCN.
If all values of all NDCs in a GCN do not match, but all values in the MedID do match, assign a new NDC to the related MedID.
If all values of any NDCs in a GCN or MedID do not match, do not assign a new NDC to the related GCN.
For any NDC that does not fall into one of the previous rules (such as new GCNs), set each NDC as Not Covered—with no other coverage values. The system places these NDCs into Pending status. Using First Data Bank (FDB) reports, a user can search each GCN/NDC and edit them manually.

When a formulary's status is changed from Inactive to Active, the system uses these rules to determine values for NDC records. The system will automatically remove NDCs that are:
No longer on the First Data Bank (FDB) NDDF (file from FDB)
Have become a repackaged drug
Have become obsolete
Have switched to an OTC indication (non-diabetes related)

The system maintains Generic Product Identifier (GPI) values using the following sequentially-applied rules. Once an NDC meets a rule, the system assigns the GIP value and that NDC is excluded from subsequent rules—except for the final step, which is an override to the previous steps.
a. If GNI (Generic Name Indicator)=0 (non-drug item), then GPI=0
b. If GNI=1 (generically-named) or Generic name=Brand Name, then GPI=1
c. If GNI=2 (brand-named) AND INNOV=1 (innovator), then GPI=2
d. If NDA (new drug application)=Y (yes), then GPI=2
e. If ANDA (abbreviated new drug application)=Y (yes), then GPI=1
f. If INNOV=0 (non-innovator) and repackage indicator=0 (non-repackager), then GPI=1
g. If INNOV=0 (non-innovator) and repackager indicator=1 (re-packager), then GPI=2
h. If an NDC is on the Argus GPI Override file, then that NDC is assigned to the GPI listed on that file.

APPENDIX 2.4
Example of Data Elements and Rules for Context Drug List Web File

| Data Element | Rule |
|---|---|
| MedID | Populated from First Data Bank. |
| Formulary ID | Populated from CF's Formulary ID. |
| Informational | Populated from informational context drug lists loaded and attached to the drug's |
| Type | Formulary. |
| B vs. D | If this drug is searched, the Medicare Drug List Search, Provider Drug List Search, |
| | Medicare Enrollment Rx Calculator, and Medicare MyHumana Rx Calculator all |
| | return coverage labeled Part B vs. Part D Determination may be required. |
| Maintenance | If the plan selected has coverage, the Medicare Drug List Search and Medicare Rx |
| | Calculator display the drug-and price, if appropriate-with Maintenance coverage |
| | in the gap. |
| Home Infusion | If the plan selected has coverage, the Medicare Drug List Search and Medicare Rx |
| | Calculator display the drug-and price, if appropriate-with Home Infusion coverage |
| | in the gap. |
| ED | If the plan selected has coverage, the Medicare Drug List Search and Medicare Rx |
| | Calculator display the drug-and price, if appropriate-with Enhanced Alternative |
| | coverage. |
| Benzo | If the plan selected has coverage, the Medicare Drug List Search and Medicare Rx |
| | Calculator will display the drug-and price, if appropriate-with Enhanced |
| | Alternative coverage. |
| Barb | If the plan selected has coverage, the Medicare Drug List Search and Medicare Rx |
| | Calculator display the drug-and price, if appropriate-with Enhanced Alternative |
| | coverage. |
| Part B only | The Medicare Drug List Search and Medicare Rx Calculator display the drug-and |
| | price, if appropriate-with Covered Under Part B. |
| SpecialtyRx | Drug Pricing, Medicare/Commercial Drug List Search, and Provider Drug List |
| | Search display specialty options corresponding to each application for this drug and |
| | formulary. |

APPENDIX 2.5
Example of Data Elements and Rules for Formulary Information Web File

| Data Element | Rule |
|---|---|
| MedID | Populated from First Data Bank. |
| Formulary ID | Populated from CF's Formulary ID. |
| Version # | Populated from latest approved HPMS Submission file corresponding to the |
| | Formulary ID. |
| Coverage | If the formulary is Medicare and drug is on the latest approved HPMS |
| | Submission file, then populates from the latest approved HPMS Submission file. |
| | Otherwise populates from the latest Formulary Ops Approved value for this drug |
| | and formulary in CF. |
| | If the formulary is commercial, populates from the latest Formulary Ops |
| | Approved value for this drug and formulary in CF. |
| Tier | Same rules as Coverage. |
| Prior Authorization | Same rules as Coverage. |
| Y/N | |
| Step Therapy | Populates from the latest Formulary Ops Approved value for this drug and |
| Prerequisite Y/N | formulary in CF. |
| Step Therapy Safety | Same rules as Step Therapy Prerequisite Y/N |
| Edit Y/N | |
| Quantity Limit Y/N | Same rules as Coverage. |
| Quantity Limit Unit | Same rules as Step Therapy Prerequisite Y/N |
| of Measure | |
| Quantity Limit Days | Same rules as Coverage. |
| Supply | |
| Quantity Limit | Same rules as Coverage. |
| Amount | |
| Age Min | Same rules as Step Therapy Prerequisite Y/N |
| Age Max. | Same rules as Step Therapy Prerequisite Y/N |
| Gender | Same rules as Step Therapy Prerequisite Y/N |
| GPI | Same rules as Step Therapy Prerequisite Y/N |

APPENDIX 2.6
Example of Data Elements and Rules for Drug Information Web File

| Data Element | Rule |
|---|---|
| MedID | Populates from First Data Bank |
| Drug Description | Populates from First Data Bank |
| GCN | Populates from First Data Bank |
| Claim Count | Populates from the Argus ODL file |
| Drug Dose and | Populates from First Data Bank |
| Form | |
| Dosage | Populates from First Data Bank |
| Form | Populates from First Data Bank |
| Route | Populates from First Data Bank |
| Retail Price per | Uses the Pricing NDC stored for both Web and Plan Finder. If the Pricing NDC |
| Unit | does not have a WAC then: |
| | If the drug is a generic, calculates the average generic price for all NDCs in the |
| | GCN. Note: WAC values that are 0 or Null are not included in the calculation of the |
| | average. |
| | If there is no average generic price-because no NDCs within the GCN have a |
| | WAC price-then CF takes the AWP for the NDC and multiplies by 49%. |
| | If the drug is a brand, then CF takes the AWP for the NDC and multiplies by 84%. |
| MAC Price | Populates from the MAC file in the CMS Plan Finder Automation Application. |
| Pricing Unit of | Populates from First Data Bank |
| Measure | |
| Common Quantity | Populates from the Argus ODL file |
| Common Days | Populates from the Argus ODL file |
| Supply | |
| Mail Price per Unit | Populates in the following manner: |
| | If the drug is on the RightSourceRx Target Drug List, uses the AWP which is 19% |
| | of the RightSourceRx Target Drug List NDC. |
| | If the drug is not on the RightSourceRx Target Drug List, then uses the WAC price |
| | of the NDC, and pushes to both the Plan Finder and the Web: |
| | If the Pricing NDC does not have a WAC then: |
| | If the drug is a generic, calculates the average generic price for all NDCs |
| | in the GCN-making sure WAC values 0 or Null are not included in the |
| | calculation of the average. |
| | If there is no average generic price-because no NDCs within the GCN |
| | have a WAC price-takes the AWP for the NDC and multiplies by 49%. |
| | If the drug is a brand, then takes the AWP for the NDC and multiplies by |
| | 84%. |

APPENDIX 2.7
Example of Data Elements and Rules for Alternative Logic Web File

| Data Element | Rule |
|---|---|
| MedID | Populates from First Data Bank. |
| Formulary ID | Populates from CF's Formulary ID. |
| Alternative | Populates from First Data Bank-using this logic: |
| MedID | Populates from alternative MedID in the MedID's ultimate child; |
| | however, if there are no alternative MedIDs in the MedID's ultimate |
| | child, then goes up one level and returns alternative MedIDs based |
| | on that ETC. |
| | Note: Accounts for overrides and changes made using CF's |
| | Override Alternatives page. |
| Coverage | If the formulary is Medicare, and the drug is on the latest approved |
| Status of | HPMS |
| Alternative | Submission file, populates from the latest approved HPMS |
| Drug | Submission file. |
| | Otherwise, populates from the latest Formulary Ops Approved |
| | value for this drug and formulary in CF. |
| | If the formulary is commercial, populates from the latest Formulary |
| | Ops Approved value for this drug and formulary in CF. |

### Appendix 2.8

### Example of Rules for Condition Web File

A Condition Search has these rules:
The search uses the ETC level that corresponds to the current level of specificity.
Only formulary data for drugs with Formulary Ops Approved status, for active Medicare and Commercial formularies, is extracted.
If there are multiple records for a particular MedID (and this is not a Medicare HPMS Proxy File drug) then the strictest record appears—Maximum Tier, PA, QL, or Step Therapy.

1. A computerized system for managing formulary data, comprising:
a server on a network with programming instructions for:
(a) receiving at said server formulary data for a plurality of drug formularies, said formulary data comprising:
(i) for each drug on said formulary, drug identifying data;
(ii) a unique formulary identifier; and
(iii) a line of business identifier corresponding to a plurality of health plans;
(b) storing said formulary data for said plurality of drug formularies in a database;
(c) receiving at said server a request for formulary data from said database, said request comprising a line of business identifier;
(d) searching said database for a plurality of formularies associated with said line of business identifier; and
(e) generating at said server a display comprising:
(i) a list of said plurality of formularies associated with said line of business identifier; and
(ii) search options for searching formulary data in said plurality of formularies associated with said line of business identifier.

2. The computerized system for managing formulary data of claim 1, wherein said formulary data comprises prior authorization data.

3. The computerized system for managing formulary data of claim 1, wherein said formulary data comprises related context drug list data.

4. The computerized system for managing formulary data of claim 1, wherein said formulary data comprises step therapy group data.

5. The computerized system for managing formulary data of claim 1, wherein the server further comprises programming instructions to create a new formulary according to directions received from a computer user.

6. The computerized system for managing formulary data of claim 1, wherein said server further comprises programming instructions to record changes made to said stored formulary data.

7. The computerized system for managing formulary data of claim 1, wherein said line of business identifier is selected from the group consisting of a governmental health plan and a commercial health plan.

8. A computerized formulary management system comprising:
a server on a network with programming instructions for:
(a) receiving at said server formulary data for a plurality of drug formularies, said formulary data comprising a unique formulary identifier for each of said drug formularies;
(b) storing said formulary data for said plurality of drug formularies in a database;
(c) receiving at said server a request comprising one of said unique formulary identifiers for a formulary from said database;
(d) receiving at said server identifying data for a destination computer system;
(e) receiving at said server a request to generate at least one file comprising formulary data for said unique formulary identifier, said file compatible with said destination computer system;
(f) generating at said server said at least one file; and
(g) transmitting said file to said destination computer system.

9. The computerized formulary management system of claim 8 wherein said destination computer system is a government health plan computer system.

10. The computerized formulary management system of claim 8 wherein said destination computer system is a commercial health plan computer system.

11. The computerized formulary management system of claim 8 wherein said destination computer system is a healthcare claims processing computer system.

12. The computerized formulary management system of claim 8 wherein said at least one file is selected from the group consisting of:
a formulary file, a prior authorization file, and a step therapy file.

13. A computerized formulary data management method, comprising:
(a) storing in a database formulary data for a plurality of formularies, said formulary data comprising:
(i) for each drug on said formulary, drug identifying data;
(ii) a unique formulary identifier; and
(iii) a line of business identifier corresponding to a plurality of health plans;
(b) receiving at said server a selection of a line of business identifier;
(c) locating in said database a plurality of formularies associated with said line of business identifier; and
(d) generating at said server a display comprising:
(i) a list of said plurality of formularies for said selected line of business identifier; and
(ii) for each formulary on said list, said unique formulary identifier.

14. The computerized formulary data management method of claim 13, wherein said formulary data comprises prior authorization data.

15. The computerized formulary data management method of claim 13, wherein said formulary data comprises related context drug list data.

16. The computerized formulary data management method of claim 13, wherein said formulary data comprises step therapy group data.

17. The computerized formulary data management method of claim 13, further comprising receiving at said server a request to generate a new formulary from a formulary selected from said list of formularies.

18. The computerized formulary data management method of claim 13, wherein said line of business identifier is selected from the group consisting of a governmental health plan and a commercial health plan.
